(19) United States
(12) Patent Application Publication
(10) Pub. No.: US 2013/0034039 A1
(43) Pub. Date: Feb. 7, 2013

(54) CONTROL DEVICE, RELAY METHOD, AND PROGRAM THEREFOR

(71) Applicants: David Liang Tai Wong, Sarawak (MY); Ettikan Kandasamy Karuppiah, Petaling Jaya (MY); Boon Hun Hwang, Selangor (MY); Hironori Nakae, Osaka (JP); Yosuke Ukita, Osaka (JP); Yuki Ohira, Osaka (JP)

(72) Inventors: David Liang Tai Wong, Sarawak (MY); Ettikan Kandasamy Karuppiah, Petaling Jaya (MY); Boon Hun Hwang, Selangor (MY); Hironori Nakae, Osaka (JP); Yosuke Ukita, Osaka (JP); Yuki Ohira, Osaka (JP)

(21) Appl. No.: 13/642,288

(22) PCT Filed: Feb. 17, 2012
(86) PCT No.: PCT/JP2012/001058

§ 371 Date: Oct. 19, 2012

(30) Foreign Application Priority Data
Feb. 18, 2011 (JP) 2011-033920

(51) Int. Cl. H04L 12/56; H04H 20/71

(52) U.S. Cl. 370/312; 370/390

(57) ABSTRACT

A control device according to the present invention comprises a receiving unit which receives, in the network, a multi-address message transmitted from each of the terminal devices, a determining unit which determines whether or not the received multi-address message is to be translated into a unicast message to be transmitted to a specified terminal device, based on information contained in the multi-address message, the specified terminal device being included in the terminal devices, a translating unit which translates the multi-address message into the unicast message when the determining unit determines that the multi-address message is to be translated, and a transmitting unit which transmits the unicast message to the specified terminal device.

### TECHNICAL FIELD

This present invention relates to control devices, and particularly to control devices for controlling consumer electronic appliances which are connected to a network.

### BACKGROUND ART

It is important for many applications or appliances (hereinafter also referred to as Consumer Electronics (CE) devices) including wireless network devices to conserve energy ensuring durability (see, Patent literature (PTL) 1 for example).

### CITATION LIST

### Patent Literature

[PTL 1] Japanese Unexamined Patent Application Publication No. 2008-48365

### SUMMARY OF INVENTION

### Technical Problem

However, conventional techniques are required to further reduce power consumption in an entire network.

In view of this, it is an object of the present invention to provide a control device which has higher power efficiency on the network.

### Solution to Problem

A control device according to an aspect of the present invention is a control device in a network including the control device and a plurality of terminal devices, the control device including a receiving unit which receives, in the network, a multi-address message transmitted from each of the terminal devices, a determining unit which determines whether or not the received multi-address message is to be translated into a unicast message to be transmitted to a specified terminal device, based on information contained in the multi-address message, the specified terminal device being included in the terminal devices, a translating unit which translates the multi-address message into the unicast message when the determining unit determines that the multi-address message is to be translated, and a transmitting unit which transmits the unicast message to the specified terminal device.

It should be noted that the present invention can be implemented not only as such a control device but also as: a data relay method which includes, as steps, the characteristic elements included in the control device; and a program which causes a computer to execute such characteristic steps. Needless to say, such a program can be distributed through a recording medium such as a Compact Disc Read Only Memory (CD-ROM) and a transmission medium such as the Internet.

In addition, the present invention can be also implemented as: a semiconductor integrated circuit (LSI) which implements a part or all of the features of such a control device; and a control system which includes such a control device.

### Advantageous Effects of Invention

A control device can be provided which enhances the power efficiency in the entire network.

### BRIEF DESCRIPTION OF DRAWINGS

FIG. 1 illustrates a basic network diagram.

FIG. 2 illustrates a functional block diagram of a control device according to embodiments of the present invention.

FIG. 3 illustrates a flowchart showing a processing flow of the control device according to the embodiments of the present invention.

FIG. 4 illustrates a relay device.

FIG. 5 illustrates an interactive device evaluator.

FIG. 6 illustrates the interactive device evaluator and a user presence evaluator.

FIG. 7 illustrates a protocol presence evaluator.

FIG. 8 illustrates the protocol presence evaluator and a functionality presence evaluator.

FIG. 9 illustrates an address translation entity having all evaluators and a state switcher.

FIG. 10 illustrates a state diagram of the state switcher.

FIG. 11 illustrates a flowchart showing a basic processing flow of the invention.

FIG. 12 illustrates a flowchart showing a detailed processing flow of the interactive device evaluator in the address translation entity.

FIG. 13 illustrates a flowchart showing a detailed processing flow of the user presence evaluator in the address translation entity.

FIG. 14 illustrates a flowchart showing a detailed processing flow of an application protocol evaluator in the address translation entity.

FIG. 15 illustrates a flowchart showing a detailed processing flow of the functionality presence evaluator in the address translation entity.

FIG. 16 illustrates a flowchart showing a detailed processing flow of a communication standard evaluator in the address translation entity.

FIG. 17 illustrates fields of an interactive device database.

FIG. 18 illustrates fields of a user presence database.

FIG. 19 illustrates fields of an application protocol database.

FIG. 20 illustrates fields of a device functionality database.

FIG. 21 illustrates fields of a communication standard database.

FIG. 22 illustrates an example of a node grouping.

FIG. 23 illustrates an IN-TRANSFORMATION message format.

FIG. 24 illustrates a sequence diagram without the interactive device evaluator and the user presence evaluator.

FIG. 25 illustrates a sequence diagram involving the interactive device evaluator and the user presence evaluator.

FIG. 26 illustrates a sequence diagram without the application protocol evaluator and the functionality presence evaluator.

FIG. 27 illustrates a sequence diagram involving the application protocol evaluator and the functionality presence evaluator.

FIG. 28 illustrates a sequence diagram without the communication standard evaluator.

FIG. 29 illustrates a sequence diagram involving the communication standard evaluator.

### DESCRIPTION OF EMBODIMENTS

A control device according to an aspect of the present invention is a control device in a network including the control device and a plurality of terminal devices, the control device including a receiving unit which receives, in the network, a multi-address message transmitted from each of the terminal devices, a determining unit which determines whether or not the received multi-address message is to be translated into a unicast message to be transmitted to a specified terminal device, based on information contained in the multi-address message, the specified terminal device being included in the terminal devices, a translating unit which translates the multi-address message into the unicast message when the determining unit determines that the multi-address message is to be translated, and a transmitting unit which transmits the unicast message to the specified terminal device.

With this, the control device can generate a group of the terminal devices which require the message received from a source node (also referred to as a source device), based on information contained in the message. In addition, unicasting only to each of the terminal devices belonging to the generated group prevents the other terminal devices from receiving unnecessary broadcast messages. Consequently, the time increases when the communication function of the terminal device can be placed into a sleep state. Therefore, the control device can be provided which enhances the power efficiency in the entire network.

Furthermore, the network may have a plurality of different protocols in a data link layer.

When the different protocols are present in the data link Layer, the control device supporting the protocols has to relay the multi-address message. Therefore, the control device according to the aspect can be employed more effectively.

In addition, when the determining unit determines that the multi-address message is not to be translated into the unicast message, the transmitting unit may translate the multi-address message into a multi-address message for each of the different protocols and transmit the translated multi-address message.

Moreover, the determining unit may identify, as the specified terminal device, from among the terminal devices, a terminal device including a display unit which presents information to a user.

With this, an unproductive processing can be eliminated such that the message to be displayed on a display, for example, a warning message for the user, is transmitted to the terminal devices without display.

In addition, the determining unit may identify, as the specified terminal device, from among the terminal devices, a terminal device into which a user inputs information during a particular time period.

With this, for example, the message about information requiring urgent action can be transmitted only to the terminal devices near each of which a user likely to be present.

More specifically, the terminal devices may be consumer electronic appliances, and the determining unit may identify, as the specified terminal device into which the user inputs information, a consumer electronic appliance which is operated by the user during the particular time period.

With this, it is determined that a user likely to be present near the terminal device which has been accepted the user's operation during the particular time period, and thus the message is unicasted to the terminal device.

In addition, the determining unit may identify, as the specified terminal device, from among the terminal devices, a terminal device supporting a particular communication protocol.

With this, it is possible to prevent the message from being relayed to the terminal device which does not support the particular communication protocol.

More specifically, the particular communication protocol may use Universal Plug and Play (UPnP).

In addition, the determining unit may identify, as the specified terminal device, from among the terminal devices, a terminal device having a particular functionality.

With this, the message can be unicasted only to the terminal device having the functionality closely related to the functionality of the source node which has transmitted the multi-address message received in the control device.

In addition, the determining unit may further determine, for each of communication protocols supported by the terminal devices, whether or not the multi-address message is to be translated into the unicast message to be transmitted.

With this, even when the terminal devices for unicast transmission use the different communication protocols, the control device can unicast to each of all the terminal devices.

More specifically, the communication protocol may be at least one of ZigBee, Institute of Electrical and Electronics Engineers (IEEE) 802.11, IEEE 802.15.4, Z-Wave, ECHONET, KNX, and Bluetooth®.

Hereinafter, the embodiments of the present invention will be described in detail with reference to drawings. Note that each of the embodiments described below is a preferable, specific example of the present invention. The numerical values, shapes, constituent elements, the arrangement and connection of the constituent elements, steps, the processing order of the steps etc. shown in the following embodiments are mere examples, and thus do not limit the present invention. The present invention is limited only by the claims. Thus, among the constituent elements in the following embodiments, constituent elements not recited in any of the independent claims indicating the most generic concept of the present invention are not essential for achieving the object of the present invention but are described as preferable constituent elements.

Conventionally, energy conservation methods to endure longer durability for Consumer Electronics (CE) devices are crucial, specifically for CE devices with wireless communication function (hereinafter, also referred to as wireless CE devices). Broadcast communication method has been used widely to notify system-wide information message to all devices in the same network. More specifically, broadcast/multicast transmission (hereinafter, also referred to as multi-address transmission) has been used to deliver specified messages without knowing the devices' communication needs or features, such as Interactive device presence, User presence, Application protocol presence, Functionality presence and Communication standard presence. In short, existing communication methods lack the ability to distinguish the intended and unintended devices, which indirectly forces all devices to receive the specified broadcast/multicast messages. In return, unintended devices waste their energy for the message processing.

This present invention provides new techniques of energy conservation of Consumer Electronics (CE) devices, specifically for wireless CE devices. These new techniques increase energy efficiency for CE devices by delivering specified messages only to intended devices with consideration of devices communication needs. More specifically, a relay device for parsing the received broadcast/multicast semantics is provided. As a result, it can be determined that multi-address transmission is appropriately retained or converted into unicast transmission based on the understanding of communication semantics requested by CE devises. Thus, the energy saving for unintended terminal devices can be achieved. The present invention not only enhances the energy efficiency, but also improves the network bandwidth and reduces network latency.

First of all, specific terms definition referred through the document is listed below.

Source: A terminal device to transmit, to a relay device, messages that can originate from the wired or wireless medium. It is also referred to as a source node.

Relay Device: An intermediate device which receives messages and translates it before sending to its destination devices. It is referred to as a control device.

Address Translation Entity: An entity responsible to evaluate and determine whether the incoming message has to be translated to broadcast/multicast or unicast transmission.

Evaluator: A generic term for an entity responsible to evaluate and decide the needs of communication transmission for each message with considerations to energy consumption, bandwidth and latency.

Interactive Device Evaluator: An evaluator that tags the incoming message to broadcast/multicast or unicast transmission based on the existence of interactive terminal devices. Interactivity of the devices can be in the form of vision, sound, smell, touch and taste.

User Presence Evaluator: An evaluator that tags the incoming message to broadcast/multicast or unicast transmission based on user presence for the terminal device.

Application Protocol Evaluator: An evaluator unit that tags the incoming message to broadcast/multicast or unicast transmission based on the message's protocol and the destination node's application protocol.

Functionality Presence Evaluator: An evaluator unit that tags the incoming message to broadcast/multicast or unicast transmission based on the relationship between the source node and the destination node.

Communication Standard Evaluator: An evaluator unit that tags the incoming message to broadcast/multicast or unicast transmission based on destination node's communication standard.

Node: A device that transmits and receives messages to or from the relay device. It is referred to as a terminal device.

Sleeping Wireless Node: A power-saving wireless device where the co-coordinator, usually access point, sends a timed beacon to inform the inactive nodes whether there is an incoming pending message. The power-saving wireless device may use an indirect polling technique for example.

Message Parser: Receives incoming message and forwards it to a database updater or a state switcher or directly into the evaluator. Incoming messages for updating the database shall be forwarded to the database updater. Incoming messages for address translation shall be forwarded to the state switcher or the evaluator.

Database Updater: The incoming message forwarded by the message parser is updated into the database.

Message Constructor: Strip off the padded information aside from the original message in the IN-TRANSFORMATION message 2100. The output from the message constructor may come in a form of multiple unicast or a single broadcast/multicast transmission.

Database Retriever: Retrieves the queried information from the database.

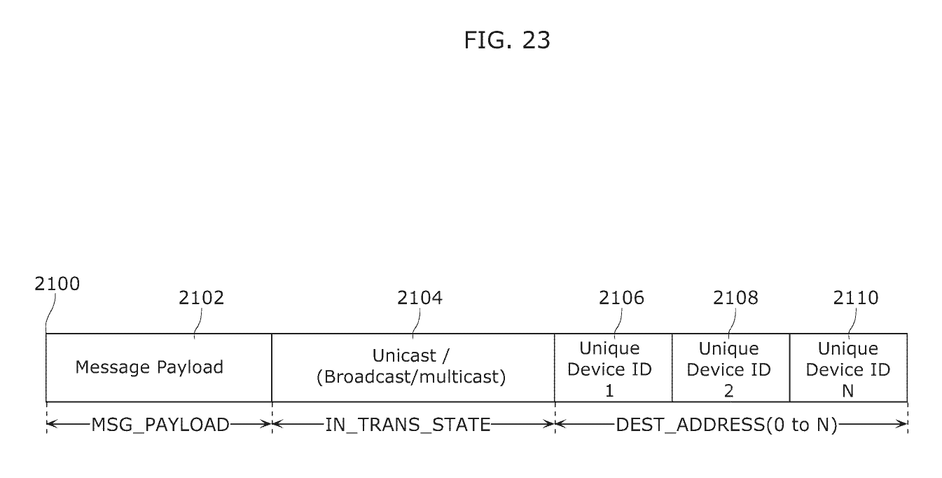

IN-TRANSFORMATION message: An incoming message that is padded with supporting information to be used for address transformation. The format consists of MSG_PAYLOAD, IN_TRANS_STATE, and DEST_ADDRESS 0 to N as shown in FIG. 23. The multi-address message relayed by the control device contains MSG_PAYLOAD. MSG_PAYLOAD contains type information for determining, in each evaluation, whether or not the message is to be translated into the unicast message. IN_TRANS_STATE and DEST_ADDRESS 0 to N indicate information for the internal processing of the control device. Therefore, IN_TRANS_STATE and DEST_ADDRESS 0 to N are added and deleted by the control device.

Address Tagger: Tags with supporting information such as IN_TRANS_STATE and DEST_ADDRESS 0 to N of IN-TRANSFORMATION message.

Address Untagger: Removes the supporting information such as IN_TRANS_STATE and DEST_ADDRESS 0 to N of IN-TRANSFORMATION message.

Interactive_Threshold: A trigger within the interactive device evaluator 700 to retain IN_TRANS_STATE 2104 in the IN-TRANSFORMATION message 2100 as broadcast/multicast transmission when surpassed a specific limit. Specifically, the trigger indicates an upper limit for the number of DEST_ADDRERSSes (2106, 2108, 2110). The trigger is quantitatively defined from the number of devices to ensure that the total amount of energy consumed for multiple unicast (shorter wakeups for devices) is lesser than broadcasting/multicasting (longer wakeups for devices).

User_Presence_Threshold: A trigger within the user presence evaluator 708 to retain IN_TRANS_STATE 2104 in the IN-TRANSFORMATION message 2100 as broadcast/multicast transmission when surpassed a specific limit. Specifically, the trigger indicates an upper limit for the number of DEST_ADDRERSSes (2106, 2108, 2110). The trigger is quantitatively defined from the number of devices to ensure that the total amount of energy consumed for multiple unicast (shorter wakeups for devices) is lesser than broadcasting/multicasting (longer wakeups for devices).

Application_Protocol_Threshold: A trigger within the application protocol evaluator 716 to retain IN_TRANS_STATE 2104 in the IN-TRANSFORMATION message 2100 as broadcast/multicast transmission when surpassed a specific limit. Specifically, the trigger indicates an upper limit for the number of DEST_ADDRERSSes (2106, 2108, 2110). The trigger is quantitatively defined from the number of devices to ensure that the total amount of energy consumed for multiple unicast (shorter wakeups for devices) is lesser than broadcasting/multicasting (longer wakeups for devices).

Communication_Protocol_Threshold: A trigger within the communication standard evaluator 732 to retain IN_TRANS_STATE 2104 in the IN-TRANSFORMATION message 2100 as broadcast/multicast transmission when surpassed a specific limit. Specifically, the trigger indicates an upper limit for the number of DEST_ADDRERSSes (2106, 2108, 2110). The trigger is quantitatively defined from the number of devices to ensure that the total amount of energy consumed for multiple unicast (shorter wakeups for devices) is lesser than broadcasting/multicasting (longer wakeups for devices).

Communication_Protocol_Battery_Threshold: A trigger within the communication standard evaluator 732 to retain IN_TRANS_STATE 2104 in the IN-TRANSFORMATION message 2100 as broadcast/multicast transmission when within a specific limit. Specifically, the trigger indicates a limit for the number of DEST_ADDRERSSes (2106, 2108, 2110). The trigger is quantitatively defined from the number of devices to ensure that the total amount of energy consumed for multiple unicast (shorter wakeups for devices) is lesser than broadcasting/multicasting (longer wakeups for devices) for battery powered devices.

Note that the systems and techniques described here relates to techniques to further conserve energy for sleeping wireless nodes with respect to the wireless power saving standards on carrier sense based on Institute of Electrical and Electronics Engineers (IEEE) 802.x standards. Ensuring the message content delivery to intended devices by means of broadcast/multicast or unicast transmission, not only energy is conserved but also improves network bandwidth and latency.

There are 5 major evaluators in the relay device that make this possible, namely the interactive device evaluator, the user presence evaluator, the application protocol evaluator, the functionality presence evaluator and the communication standard evaluator. As a result of using these systems and techniques, multiple conditions together with database retrieval are evaluated to determine the outcome of the relayed message.

In wireless power saving techniques, all sleeping wireless devices wake up based on synchronization using beacon frames transmitted from the relay device serving as a base station. If the current beacon frame indicates broadcast/multicast transmission, all devices were to wait until the broadcast/multicast message is received. However, the broadcast/multicast message may not be understood or intended for all devices but only useful for 2 or 3 devices. Thus, to avoid all devices to wait for the reception of the broadcast/multicast message after the beacon frame indicator, the broadcast/multicast is translated to unicast for the intended devices by the relay device. Therefore, the relay device does not unicast the broadcast/multicast message to each of all the devices sequentially, and instead unicasts only to each of the intended devices after narrowing down destination devices to the devices requiring the broadcast/multicast message.

Taking the home network as a mere example where there is a plurality of wireless devices using power saving techniques by means of indirect polling to the base station, the reduction of broadcast/multicast UPnP message can reduce the duration of wakeups thus extending battery life of sensor devices and overall power consumption. If a broadcast/multicast message is transmitted once for every 30 seconds, 2880 broadcast/multicast messages are transmitted within 24 hours. This causes longer wakeups. In addition, unnecessary message parsing for plurality of sleeping wireless devices leads to shorter battery life, and overall power consumption increases. Thus, it is useful for the invention to convert these broadcast/multicast messages into unicast transmission without losing the semantics of the intended recipient.

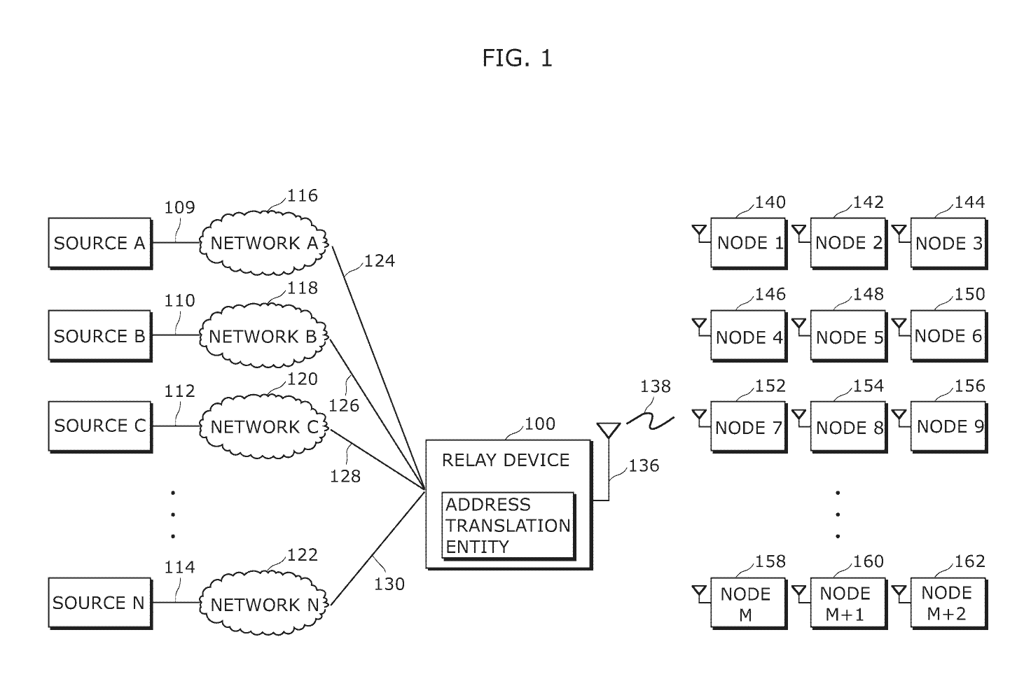

FIG. 1 illustrates an overview of network topology. Note that the present invention is not limited to multiple networks A to N (116, 118, 120, 122), nodes 1 to M+2 each of which is a sleeping wireless node (140, 142, 144, 146, 148, 150, 152, 154, 156, 158, 160, 162), source nodes A to N, and a relay device 100 as shown in FIG. 1. Note that the relay device 100 is also described as the control device 100.

The relay device 100 comprises of an address translation entity. The source A is connected to the network A 116 through a connection 109. The network A is connected to the relay device 100 through a connection 124. This connection layout is applicable to the other source nodes B to N each of which is connected to a network (118, 120, 122) through a connection (110, 112, 114). Furthermore, this connection layout is also applicable to the other networks (118, 120, 122) each connected to the relay device 100 through a connection (126, 128, 130).

The connection (109, 110, 112, 114, 124, 126, 128, 130) is not limited to a specific wired or wireless medium. The relay device 100 attached with wireless communication interface 136, which may corresponds to different standards, communicates to the sleeping wireless node (140, 142, 144, 146, 148, 150, 152, 154, 156, 158, 160, 162) wirelessly through the connection 138. Note that the source nodes (100, 102, 104, 106) may originate from sleeping wireless nodes (140, 142, 144, 146, 148, 150, 152, 154, 156, 158, 160, 162).

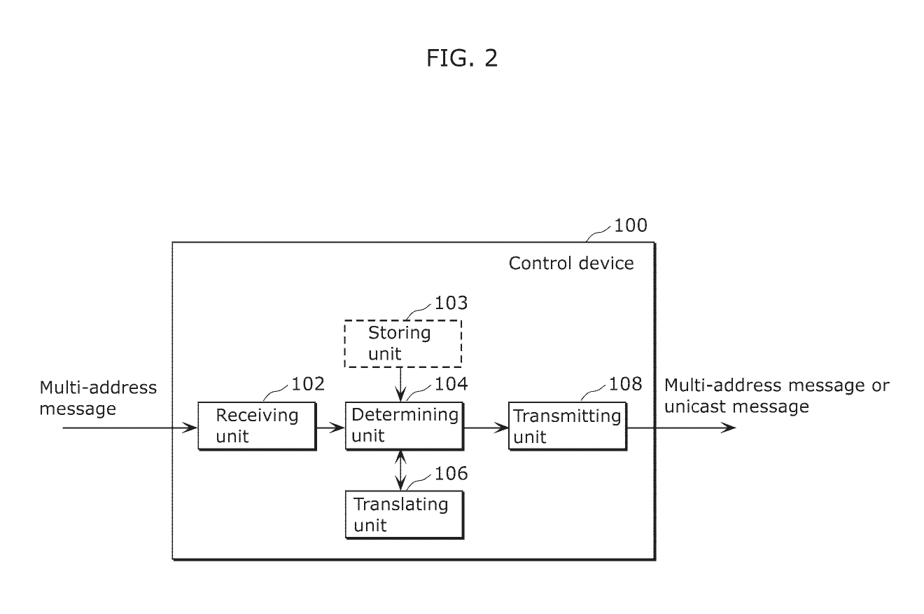

FIG. 2 illustrates a functional block diagram of a control device 100 according to the embodiments of the present invention.

The control device 100 is a control device in a network including the control device 100 and multiple terminal devices.

As shown in FIG. 2, the control device 100 includes a receiving unit 102, a storing unit 103, a determining unit 104, a translating unit 106, and a transmitting unit 108. Note that the address translation entity includes the storing unit 103, the determining unit 104, and the translating unit 106.

The receiving unit 102 receives in the network a multi-address message transmitted from each of the terminal devices, by wired or wireless connections.

The storing unit 103 stores information on each terminal device. Note that the storing unit 103 may be a database provided outside the control device 100 for example. In this case, the control device 100 can obtain necessary information without the storing unit 103 by querying the outside database via the network. This will be described below in detail.

The determining unit 104 determines whether or not the multi-address message received by the receiving unit 102 is to be translated into a unicast message to be transmitted to a specified terminal device, based on information contained in the multi-address message, the specified terminal device being included in the terminal devices.

The translating unit 106 translates the multi-address message into the unicast message when the determining unit 104 determines that the multi-address message is to be translated

The transmitting unit 108 transmits the unicast message to the specified terminal device by wired or wireless connections.

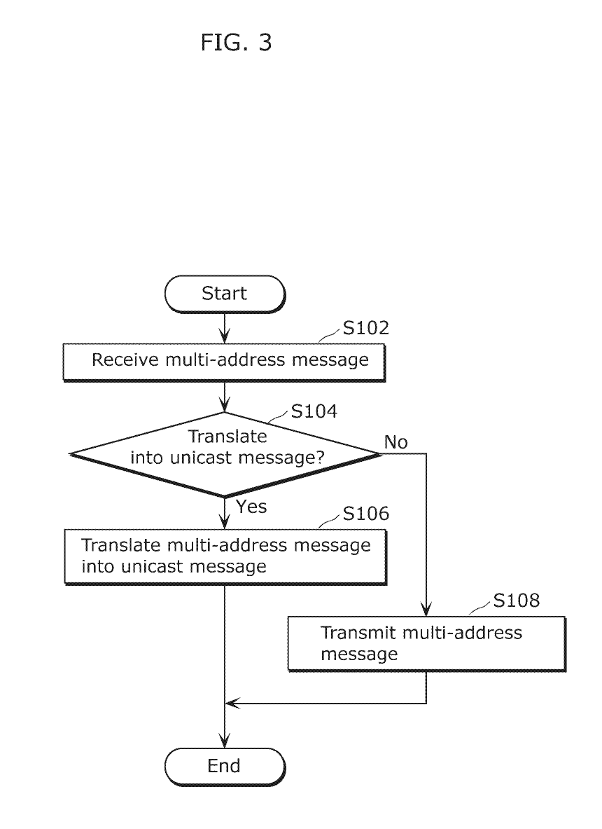

FIG. 3 illustrates a flowchart showing a processing flow of the control device 100 according to the embodiments of the present invention.

First, the receiving unit 102 receives the multi-address message (S102), and the determining unit 104 determines whether or not the received multi-address message is to be translated into the unicast message (S104).

In this step, when the determining unit 104 determines that the received multi-address message is to be translated into the unicast message (Yes in S104), the translating unit 106 translates the received multi-address message into the unicast message (S106).

On the other hand, when the determining unit 104 determines that the received multi-address message is not to be translated into the unicast message (No in S104), the transmitting unit 108 transmits the multi-address message to the terminal devices as a multi-address message (S108).

Note that when the network has multiple different protocols in the data link Layer, the transmitting unit 108 may translate the multi-address message into a message for each different protocol and transmit the message as a multi-address message for the terminal devices which communicate using the same protocol.

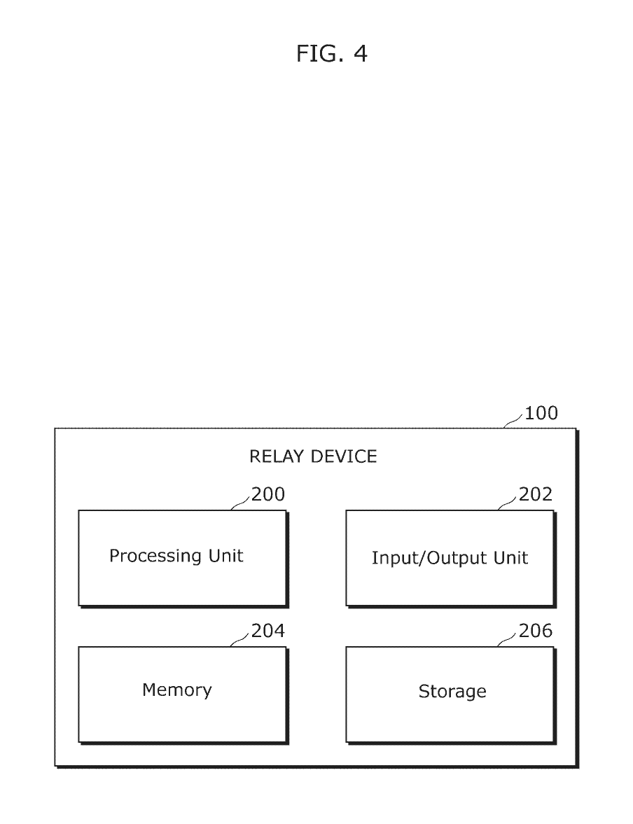

Note that each of the structural elements included in the relay device 100 can be implemented using a computing machine for example. FIG. 4 illustrates a hardware configuration of the relay device 100 including a processing unit 200, an input and output unit 202, a memory 204, and a storage 206. The processing unit 200 executes arithmetic processing necessary for address translation entity functionalities described below. The processing unit 200 may be a discrete device or an embedded processor. The memory 204 caches the processing packets for the address translation entity. The memory 204 may be an internal register, an internal memory, or an external memory. The storage 206 holds a database for managing information on the terminal devices. The storage 206 may be an internal or external permanent storage disk. The input and output unit 202 may have one or more interfaces. In addition, the interfaces which are wired and wireless, or all of which are wireless may be used as the interfaces for the incoming and outgoing packets from network. The address translation entity described below can be implemented as a hardware or software solution of a relay device 100.

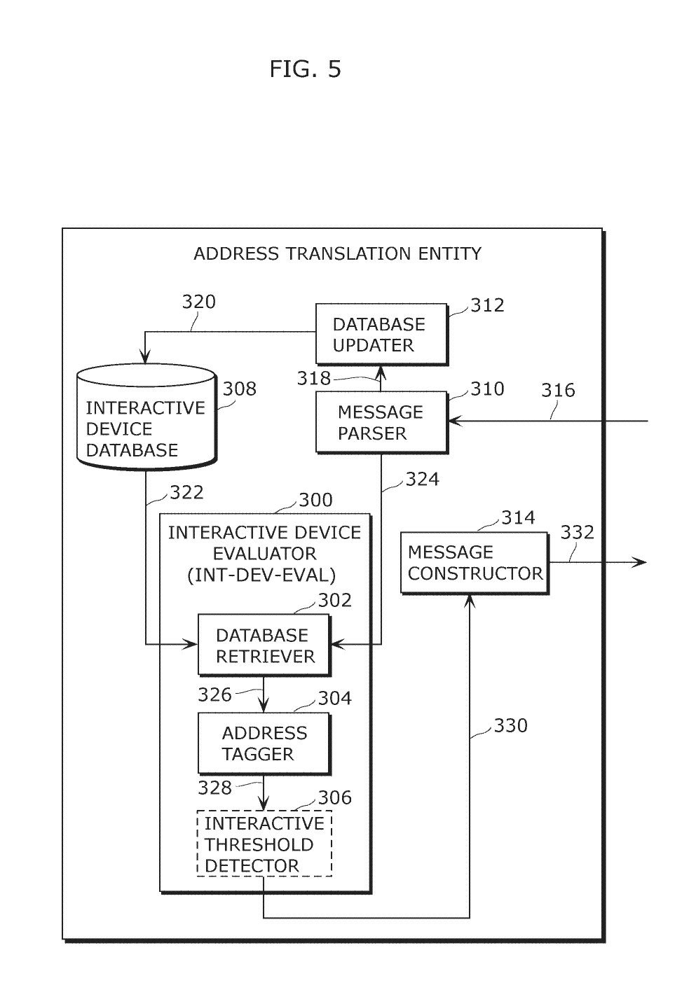

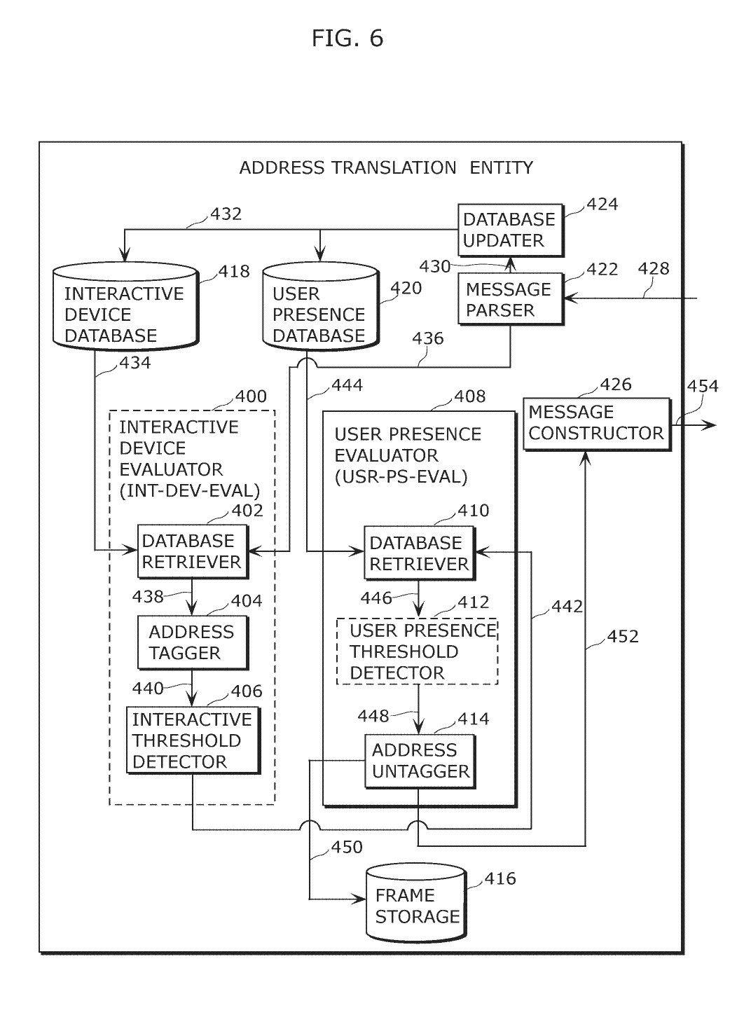

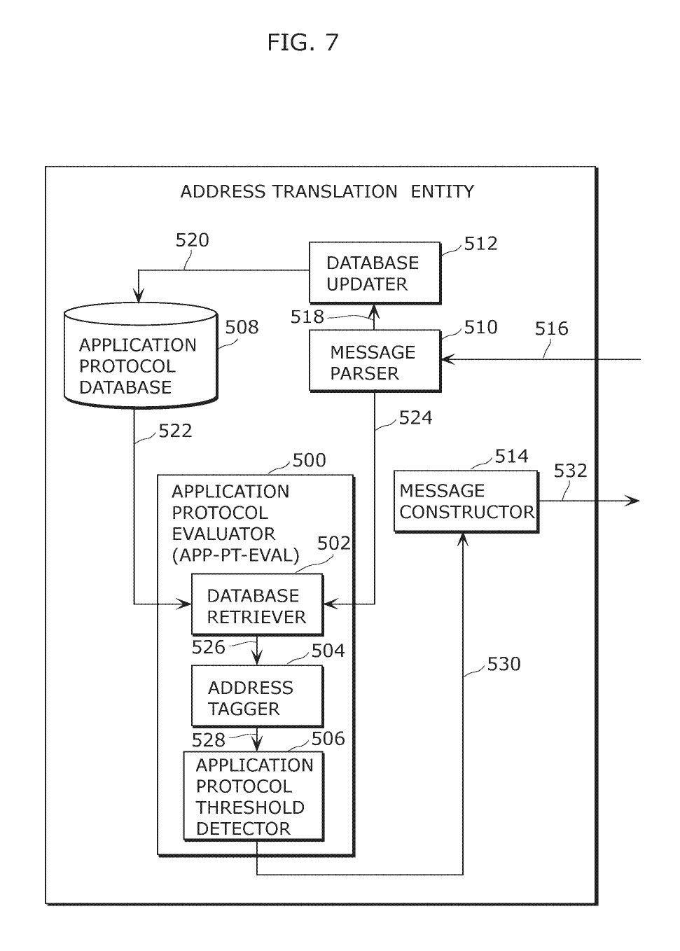

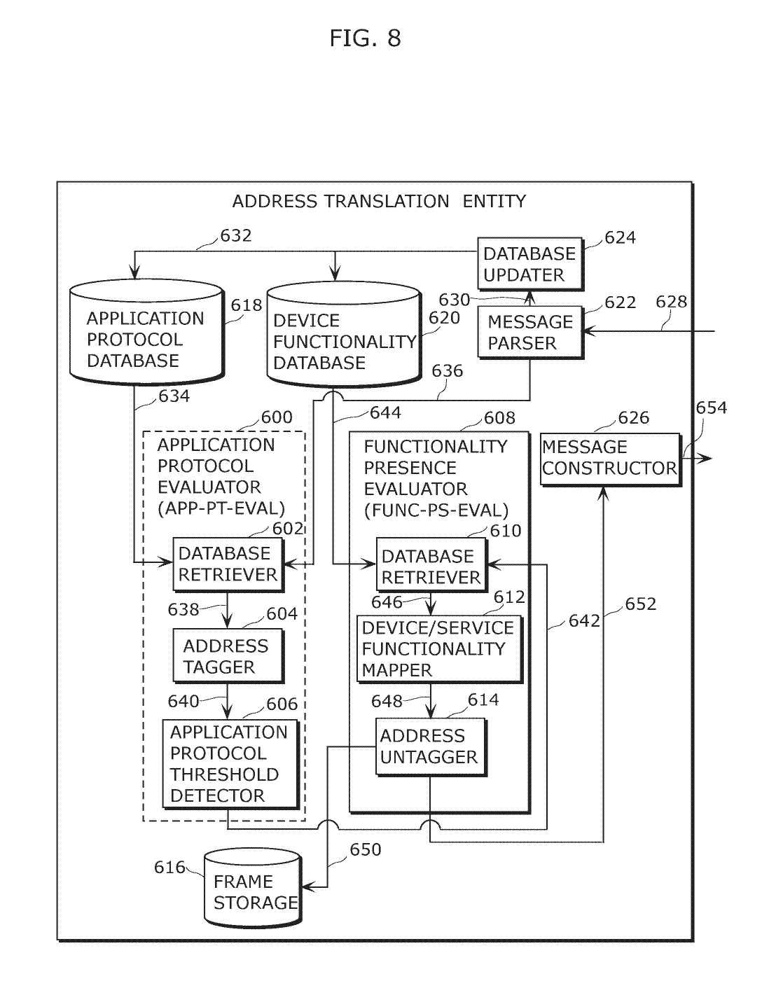

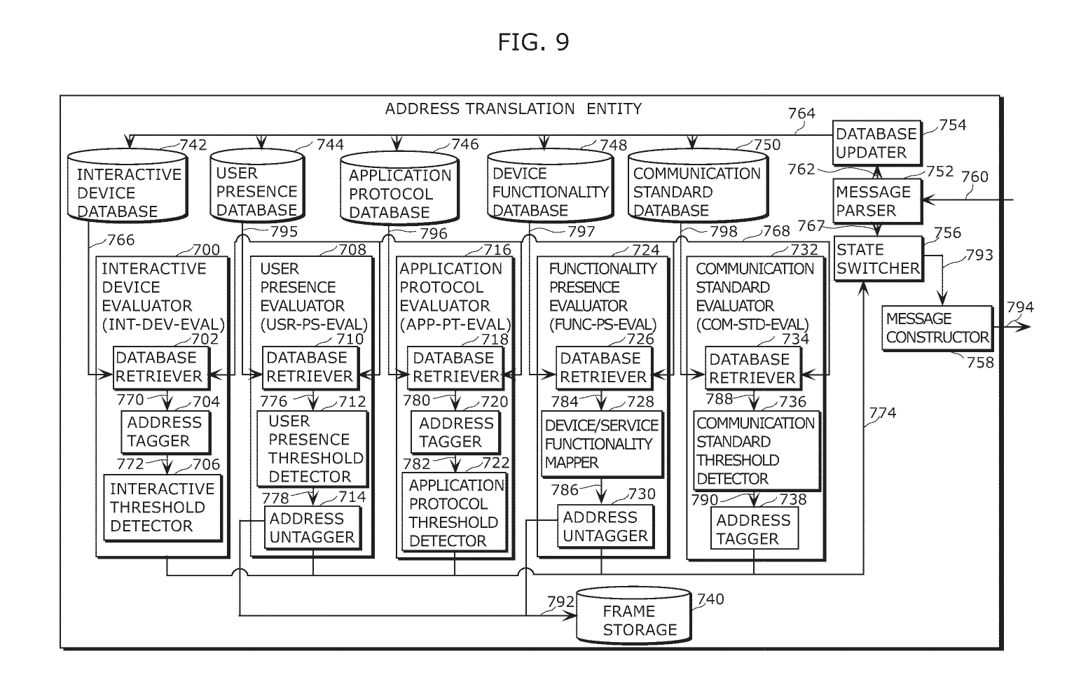

Each of FIG. 5, FIG. 6, FIG. 7, FIG. 8, and FIG. 9 illustrates an exemplary structure of the address translation entity included in the control device 100 according to the embodiments. The respective figures are different structures of the address translation entity and can be executed independently. Note that, as described above, the address translation entity corresponds to the storing unit 103, the determining unit 104, and the translating unit 106 included in the control device 100.

Hereinafter, criteria will be described in detail which the determining unit 104 included in the address translation entity uses to determine whether or not the multi-address message is to be translated into the unicast message.

FIG. 5 illustrates the apparatus around and within the interactive device evaluator 300.

For example, the interactive device evaluator 300 and the message parser 310 correspond to the determining unit 104. Moreover, an interactive device database corresponds to the storing unit 103. Furthermore, the message constructor 314 corresponds to the translating unit 106.

The interactive device evaluator 300 includes the database retriever 302, the address tagger 304, and an interactive threshold detector 306. The units surrounding the interactive device evaluator 300 includes the message parser 310, the database updater 312, the interactive device database 308, and the message constructor 314.

The received incoming message, IN-TRANSFORMATION message 2100 illustrated on FIG. 23 with only the MSG_PAYLOAD 2102 at this point, enters the address translation entity through a connection 316. The IN-TRANSFORMATION message 2100 enters the message parser 310.

The massager parser 310 parses the semantics of the IN-TRANSFORMATION message 2100. Then the type information in the IN-TRANSFORMATION message 2100 obtained by parsing is forwarded to the database updater 312 through a connection 318. The type information of the IN-TRANSFORMATION message 2100 is contained in MSG_PAYLOAD of IN-TRANSFORMATION message 2100 and used for the address translation entity to determine whether or not the unicast translation is needed.

In this embodiment, the IN-TRANSFORMATION message 2100 contains the type information indicating whether or not the message is an interactive related message which can be contained in the form of Layer 2 protocol. Note that Layer 2 protocols include, but are not limited to, Institute of Electrical and Electronics Engineers (IEEE), Link Layer Discovery Protocol (LLDP), and Microsoft Link Layer Topology Discovery (LLTD).

The database updater 312 updates the interactive device database 308 through a bus connection 320.

The message parser 310 triggers the interactive device evaluator 300. The message parser 310 also inputs the IN-TRANSFORMATION message 2100 to the database retriever 302 through a connection 324.

More specifically, the massager parser 310 receives the IN-TRANSFORMATION message and then references the type information contained in the IN-TRANSFORMATION message. In this manner, the message parser 310 determines the type of IN-TRANSFORMATION message. At this point, when the type information contained in the IN-TRANSFORMATION message 2100 indicates that the IN-TRANSFORMATION message is to be transmitted only to the interactive devices, the message parser 310 inputs the IN-TRANSFORMATION message to the interactive device evaluator 300.

In this case, the database retriever 302 retrieves a list of information related to the interactive devices from the interactive device database 308 through a connection 322. The database retriever 302 also triggers the address tagger 304 through a connection 326. The address tagger 304 tags the IN-TRANSFORMATION message 2100 with a unique device ID (2106, 2108, 2110) of DEST_ADDRESS 0 to DEST_ADDRESS N (hereinafter also referred to as DEST_ADDRESS 0 to N) field. The address tagger 304 also determines whether IN_TRANS_STATE 2104 in the IN-TRANSFORMATION message 2100 is set to information indicating multi-address transmission (for example, broadcast/multicast transmission) or information indicating unicast transmission.

For example, the address tagger 304 tags the field of unique device ID in the IN-TRANSFORMATION message 2100 with the ID of the terminal device listed as the interactive device, which is obtained from the interactive device database 308. The address tagger also sets IN_TRANS_STATE 2104 to the information representing unicast transmission. Note that, the address tagger 304 may set IN_TRANS_STATE 2104 to the information representing multi-address transmission when the number of the IDs of the terminal devices listed as the interactive devices, which are obtained from the interactive device database 308, is equal to 0.

Furthermore, the address tagger 304 may trigger the interactive threshold detector 306 through a connection 328. In this case, the interactive threshold detector 306 may set IN_TRANS_STATE 2104 to the information representing multi-address transmission when the number of the IDs of the terminal devices listed as the interactive devices, which are obtained from the interactive device database 308, is not less than a predetermined number. It is because a single multi-address transmission is believed to communicate more efficiently as compared to multiple unicast transmissions. Note that the interactive device evaluator 300 need not include the interactive threshold detector 306.

Subsequently, the message constructor 314 receives the IN-TRANSFORMATION message through a connection 330. In addition, the message constructor 314 transmits the IN-TRANSFORMATION message through a connection 332.

Note that the interactive device specifically refers to a terminal device with a display unit such as a liquid crystal display. Thus, the determining unit 104 may identify the terminal device with a display unit which presents information to a user, from among the terminal devices as the specified terminal device for unicast transmission.

Next, FIG. 6 illustrates the units within the interactive device evaluator 400, the user presence evaluator 408, and their peripheral components.

FIG. 6 is an addition of FIG. 5 with the user presence evaluator 408. Same labels and description between FIG. 5 and FIG. 6 are (316, 428), (312, 424), (320, 432), (308, 418), (322, 434), (324, 436), (300, 400), (302, 402), (326, 438), (304, 404), (328, 440), (306, 406), (314, 426), and (332, 454).

Note that the interactive device evaluator 400, the user presence evaluator 408, and the message parser 422 correspond to the determining unit 104. Moreover, the interactive device database 418 and a user presence database 420 correspond to the storing unit 103. Furthermore, the message constructor 426 corresponds to the translating unit 106.

The user presence evaluator 408 includes the database retriever 410, a user presence threshold detector 412, and the address untagger 414.

The additional units surrounding the user presence evaluator 408 are the user presence database 420 and a frame storage 416.

The massager parser 422 parses the semantics of the IN-TRANSFORMATION message 2100. Then the type information in the IN-TRANSFORMATION message 2100 obtained by parsing is forwarded to the database updater 424 through a connection (318, 430).

In this embodiment, the IN-TRANSFORMATION message 2100 contains the type information indicating whether or not the message is a user presence information related message which can be contained in the form of Layer 2 protocol. The type information indicates whether or not a user communicates with the terminal device. For example, the user presence information includes the last user commands issued by a remote control (1602, 1604 in FIG. 18), human visual attention on the device (1602, 1604 in FIG. 18), device status (1606 in FIG. 18) with respect to human interaction. However, the user presence information is not limited to them. The Database Updater (312, 424) then updates the user presence database 420 through the bus connection (320, 432).

The interactive threshold detector (306, 406) receives the IN-TRANSFORMATION message 2100 and then references the type information in the IN-TRANSFORMATION message. At this point, when the type information contained in the IN-TRANSFORMATION message indicates that the IN-TRANSFORMATION message is to be transmitted only to the terminal devices specified by the user presence information, the message parser 422 inputs the IN-TRANSFORMATION message to the user presence evaluator 408.

In this case, the database retriever 410 included in the user presence evaluator 408 is invoked through a connection 442. Note that the message parser 422 may output the IN-TRANSFORMATION message 2100 to the interactive device evaluator 400 first when the interactive device evaluator 400 and the user presence evaluator 408 are connected in series as shown in FIG. 6.

The database retriever 410 retrieves a list of information related to user presence from the user presence database 420 through a connection 444. The database retriever 410 triggers the user presence threshold detector 412 through a connection 446 to determine whether forwarded unique device ID (2106, 2108, 2110) of DEST_ADDRESS 0 to N field from the interactive device evaluator 400 is to be untagged. The user presence threshold detector 412 triggers the address untagger to appropriately untag the IN-TRANSFORMATION message 2100 with the unique device ID (2106, 2108, 2110) of DEST_ADDRESS 0 to N field through a connection 448.

For example, the user presence threshold detector 412 may determine that multi-address transmission to all the terminal devices is better for communication efficiency when the number of terminal devices around each of that a user is present, which are obtained from the user presence database 420, is not less than the predetermined threshold. In this case, the user presence threshold detector 412 may delete the terminal device's ID with which the interactive device evaluator 400 tags the IN-TRANSFORMATION message as the intended terminal device for unicast transmission. Note that the user presence evaluator 408 need not include the user presence threshold detector 412.

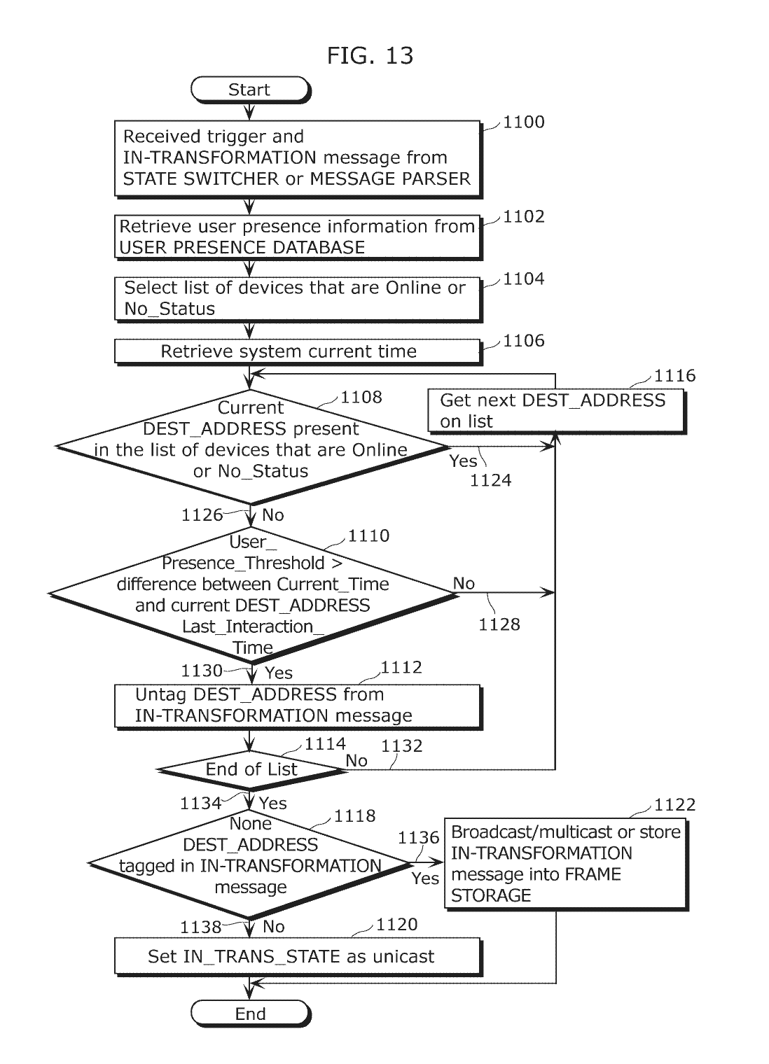

The address untagger 414 determines, based on the predetermined condition (FIG. 13, Step 1118), whether IN_TRANS_STATE 2104 in the IN-TRANSFORMATION message 2100 is set to broadcast/multicast or unicast transmission or the IN-TRANSFORMATION message 2100 is forwarded to the frame storage 416.

The address untagger 414 is connected to the frame storage 416 via a connection 450. The frame storage 416 stores the IN-TRANSFORMATION message 2100 if there is no DEST_ADDRESS 0 to N field in the IN-TRANSFORMATION message 2100 based on the predetermined condition (FIG. 13, Step 1118). The IN-TRANSFORMATION message 2100 in the frame storage 416 shall be sent when a user is present or sent over another network (116, 118, 120, 122) where the user is present. The address untagger 414 triggers the message constructor 426 through a connection 452.

Note that the user presence information indicates, particularly, the terminal device into which a user for the terminal device inputs information during a particular time period. For example, when the user changes TV channels by remote control within last 30 minutes, the user presence database stores the ID representing the TV. Similarly, when the user uses an Induction Heating (IH) cooking device within last 5 minutes, the user presence database stores the ID representing the IH cooking device.

Thus, the determining unit 104 may identify, as the specified terminal device for unicast transmission, from among the terminal devices, the terminal device into which a user inputs information during the particular time period. More specifically, the terminal devices may be consumer electronic appliances, and the determining unit 104 may identify, as the specified terminal device into which the user inputs information, the consumer electronic appliance which is operated by the user during the particular time period.

FIG. 7 illustrates the apparatus around and within the application protocol evaluator 500. Same labels and description between FIG. 5 and FIG. 7 are (316, 516), (320, 520), (314, 514), and (332, 532).

Note that the application protocol evaluator 500 and the message parser 510 correspond to the determining unit 104. In addition, an application protocol database 508 corresponds to the storing unit 103. Furthermore, the message constructor 514 corresponds to the translating unit 106.

The application protocol evaluator 500 includes the database retriever 502, the address tagger 504, and an application protocol threshold detector 506.

The additional units surrounding the application protocol evaluator 500 is the application protocol database 508.

The IN-TRANSFORMATION message 2100 enters the message parser 510. Next, the massage parser 510 parses the semantics of the IN-TRANSFORMATION message. Then the message parser 510 forwards the type information in the IN-TRANSFORMATION message obtained by parsing to the database updater 512 through a connection 518.

The IN-TRANSFORMATION message contains the type information indicating an application protocol type which can come in the form of Layer 2 protocol. Note that Layer 2 protocols include IEEE Link Layer Discovery Protocol (LLDP) and Microsoft Link Layer Topology Discovery (LLTD) protocol. However, the Layer 2 protocols are not limited to them. In addition, the source supporting the application protocol supported can also be discovered through MSG_PAYLOAD 2102 in the IN-TRANSFORMATION message 2100 by its Layer 4 protocol header. The database updater 512 then updates the application protocol database 508 through a bus connection 520.

The message parser 510 can also trigger the application protocol evaluator 500 and the IN-TRANSFORMATION message 2100 enters into the database retriever 502 through a connection 524.

The massager parser 310 receives the IN-TRANSFORMATION message and then references the type information contained in the IN-TRANSFORMATION message. At this step, when the type information contained in the IN-TRANSFORMATION message indicates a particular protocol type, the message parser 510 inputs the IN-TRANSFORMATION message into the application protocol evaluator 500.

In this case, the database retriever 302 retrieves a list of information related to the application protocol supported by the terminal device from the application protocol database 508 through a connection 522.

The database retriever 502 triggers the address tagger 504 through a connection 526. The address tagger 504 tags the IN-TRANSFORMATION message 2100 with a unique device ID (2106, 2108, 2110) of DEST_ADDRESS 0 to N field. The reception of the IN-TRANSFORMATION message 2100 then triggers the application protocol threshold detector 506 through a connection 528 to determine whether IN_TRANS_STATE 2104 in the IN-TRANSFORMATION message 2100 is set to broadcast/multicast or unicast transmission.

The application protocol threshold detector 506 triggers the message constructor 514 through a connection 530. The message constructor 514 sends the message through a connection 532.

Thus, the determining unit 104 may identify, as the specified terminal device for unicast transmission, from among the terminal devices, the terminal device supporting a particular communication protocol. For example, the particular communication protocol may use Universal Plug and Play (UPnP).

FIG. 8 illustrates the apparatus around and within the application protocol evaluator 600 and the functionality presence evaluator 608. FIG. 8 is an addition of FIG. 7 with the functionality presence evaluator 608. Same labels and description between FIG. 7 and FIG. 8 are (516, 628), (512, 624), (520, 632), (508, 618), (522, 634), (524, 636), (500, 600), (502, 602), (526, 638), (504, 604), (528, 640), (506, 606), (514, 626), and (532, 654). Same labels and description between FIG. 6 and FIG. 8 is (416, 616).

The functionality presence evaluator 608 includes the database retriever 610, a device/service functionality mapper 612, and the address untagger 614. The additional units surrounding the functionality presence evaluator 608 are a device functionality database 620 and a frame storage 616.

Note that the application protocol evaluator 600, the functionality presence evaluator 608 and the message parser 622 correspond to the determining unit 104. Moreover, the application protocol database 618 and the device functionality database 620 correspond to the storing unit 103. Furthermore, the message constructor 626 corresponds to the translating unit 106.

The massager parser 622 parses the semantics of the IN-TRANSFORMATION message 2100. Then the type information in the IN-TRANSFORMATION message 2100 obtained by parsing is forwarded to the database updater 624 through a connection 630.

The IN-TRANSFORMATION message 2100 contains the type information indicating the functionality of the terminal device, which can be contained in the form of Layer 2 protocol. Note that Layer 2 protocols include IEEE Link Layer Discovery Protocol (LLDP) and Microsoft Link Layer Topology Discovery (LLTD) protocol. However, the Layer 2 protocols are not limited to them. In addition, the relationship of the device/functionality mapping can also be discovered through MSG_PAYLOAD 2102 in the IN-TRANSFORMATION message 2100 by its Layer 4 protocol payload. The database updater (512, 624) then updates the device functionality database 620 through a bus connection (520, 632).

When the application protocol threshold detector 606 receives the IN-TRANSFORMATION message 2100, the database retriever 610 of the functionality presence evaluator 608, which is invoked through a connection 642, retrieves a list of information related to device functionality relationship from the device functionality database 620 through a connection 644.

The database retriever 610 triggers the device/service functionality mapper 612 through a connection 646 to determine whether the forwarded unique device ID (2106, 2108 and 2110 in FIG. 23) of DEST_ADDRESS 0 to N field from the application protocol evaluator 600 is to be untagged.

The device/service functionality mapper 612 triggers the address untagger to appropriately untag the IN-TRANSFORMATION message 2100 with the unique device ID (2106, 2108, 2110) of DEST_ADDRESS 0 to N field through a connection 648.

For example, the functionality presence evaluator 608 references the device functionality database 620 to determine whether or not the number of terminal devices each having the specified functionality designated in the IN-TRANSFORMATION message 2100 is not less than the predetermined threshold. When the number is not less than the predetermined threshold, it may be determined that multi-address transmission to all the terminal devices is better for communication efficiency. In this case, the functionality presence evaluator 608 may delete the terminal device's ID with which the application protocol evaluator 600 tags the IN-TRANSFORMATION message as the intended terminal device for unicast transmission.

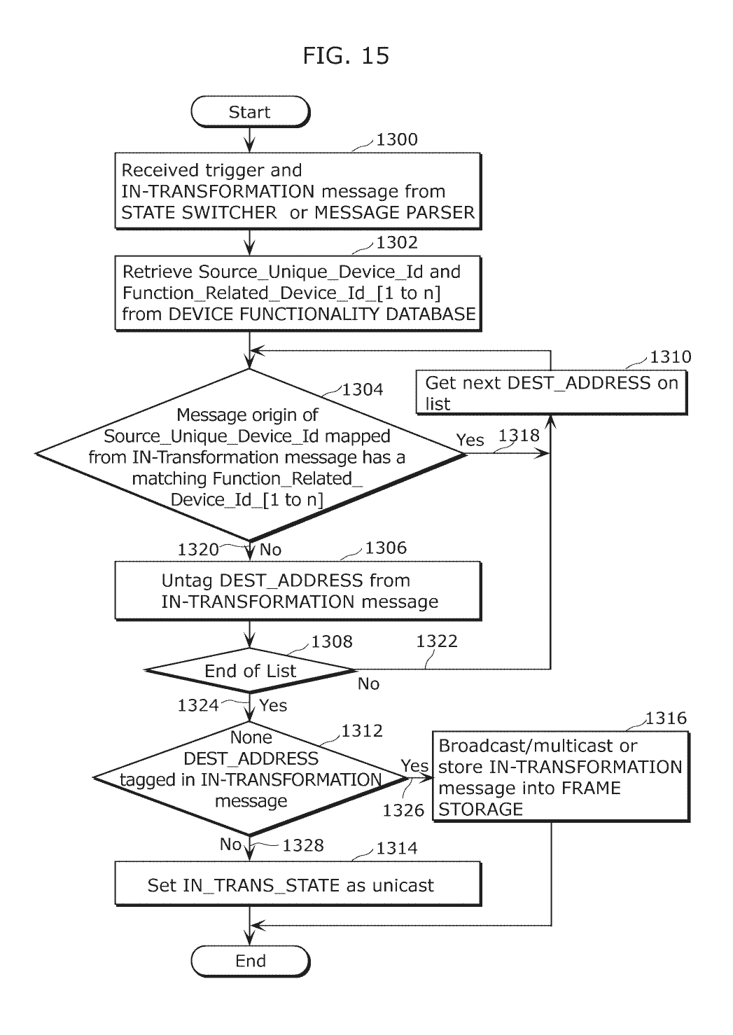

The address untagger 614 determines, based on the predetermined condition (FIG. 15, Step 1312), whether IN_TRANS_STATE 2104 in the IN-TRANSFORMATION message 2100 is set to broadcast/multicast or unicast transmission or the IN-TRANSFORMATION message 2100 is forwarded to the frame storage 616.

The address untagger 614 is connected to the frame storage 616 via a connection 650. The frame storage 616 stores the IN-TRANSFORMATION message 2100 if there is no DEST_ADDRESS 0 to N field in the IN-TRANSFORMATION message 2100 based on the predetermined condition (FIG. 15, Step 1312). The IN-TRANSFORMATION message in the frame storage 616 is sent when any device connected matches with its device functionality relationship. The address untagger 614 triggers the message constructor 626 through a connection 652.

Note that the functionalities which the device functionality database 620 stores for each terminal device may include server's function and client's function for in-home distribution of video content, energy-saving function, and Audio Visual (AV) data regeneration function. Thus, the determining unit 104 may identify, as the specified terminal device for unicast transmission, from among the terminal devices, the terminal device having a particular functionality.

Note that the control device 100 may include the interactive device evaluator, the user presence evaluator, the application protocol evaluator, the functionality presence evaluator, as described above, or any combination of them. In addition, the determining unit may determine, for each of communication protocols supported by the terminal devices, whether or not the multi-address message is to be translated into the unicast message to be transmitted.

FIG. 9 illustrates the overall interconnection of major components including the interactive device evaluator 700, the user presence evaluator 708, the application protocol evaluator 716, the functionality presence evaluator 724, the communication standard evaluator 732, and the state switcher 756. In FIG. 9, the additional entities introduced are the communication standard evaluator 732 and the state switcher 756.

Same labels and description between FIG. 5, FIG. 6, FIG. 7, FIG. 8, and FIG. 9 are as follows: (316, 428, 516, 628, 760), (320, 432, 520, 632, 764), (308, 418, 742), (322, 434, 766), (300, 400, 700), (302, 402, 702), (326, 438, 770), (304, 404, 704), (328, 440, 772), (306, 406, 706), (444, 795), (408, 708), (410, 710), (446, 776), (412, 712), (448, 778), (414, 714), (522, 634, 796), (500, 600, 716), (502, 602, 718), (526, 638, 780), (504, 604, 720), (528, 640, 782), (506, 606, 722), (644, 797), (608, 724), (610, 726), (646, 784), (612, 728), (648, 786), (614, 730), (450, 650, 792), (416, 616, 740), (314, 426, 514, 626, 758), and (332, 454, 532, 654, 794).

Note that the interactive device evaluator 700, the user presence evaluator 708, the application protocol evaluator 716, the functionality presence evaluator 724, the communication standard evaluator 732, the message parser 752, and the state switcher 756 correspond to the determining unit 104. In addition, the interactive device database 742, the user presence database 744, the application protocol database 746, the device functionality database 748, and a communication standard database 750 correspond to the storing unit 103. Furthermore, the message constructor 758 corresponds to the translating unit 106.

The communication standard evaluator 732 includes the database retriever 734, the communication standard threshold detector 736, and the address tagger 738. The additional unit supporting the communication standard evaluator 732 is the communication standard database 750.

The message parser (312, 422, 510, 622, 752) parses the semantics of the IN-TRANSFORMATION message 2100. Then the type information in the IN-TRANSFORMATION message 2100 obtained by parsing is forwarded to the database updater (310, 424, 512, 624, 754) through a connection (318, 430, 518, 630, 762).

The IN-TRANSFORMATION message 2100 contains the type information indicating semantics related to communication standard and battery powered, which can be contained in the form of Layer 2 protocol. Note that Layer 2 protocols include, but not limited to, IEEE Link Layer Discovery Protocol (LLDP) and Microsoft Link Layer Topology Discovery (LLTD) protocol.

The database updater (318, 430, 518, 630, 762) then updates the communication standard database 750 through the bus connection (320, 432, 520, 632, 764).

The state switcher 756 receives the IN-TRANSFORMATION message 2100 invoked by the message parser 752 through a connection 767. Upon receiving the IN-TRANSFORMATION message 2100 from the state switcher 756 through a connection 768, the database retriever 734 of the communication standard evaluator 732 retrieves a list of device communication standard and power source information from the communication standard database 750 through a connection 798.

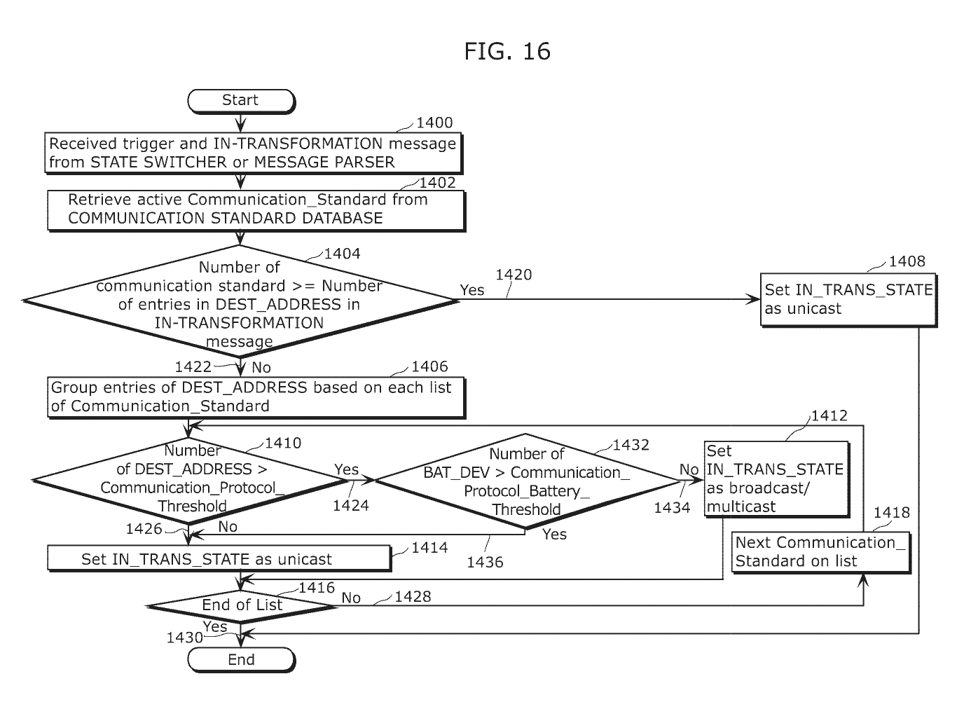

The database retriever 734 triggers the communication standard threshold detector 736 through a connection 788 to determine whether the unique device ID (2106, 2108, 2110) of DEST_ADDRESS 0 to N field from the state switcher 756 has a one device to one communication standard relationship (1404 in FIG. 16). The control device 100 groups the terminal devices based on the communication standard (1406 in FIG. 16). Then the communication standard threshold detector 736 determines whether the number of terminal devices supporting the communication standard designated in the type information and the number of battery-powered terminal devices surpass a communication standard threshold 1410 and a communication standard battery threshold 1432, respectively. Consequently, when the number of terminal devices included in a group surpasses each threshold, the multi-address message is transmitted with no translation. On the other hand, when the number of terminal devices does not surpass each threshold, the multi-address message may be translated into the unicast message to be transmitted.

In other words, the determining unit 104 may determine, for each of communication protocols supported by the terminal devices, whether or not the multi-address message is to be translated into the unicast message to be transmitted.

Note that any communication protocol can be used for the determination of the determining unit 104. For example, the communication protocol may be at least one of ZigBee, Institute of Electrical and Electronics Engineers (IEEE) 802.11, IEEE 802.15.4, Z-Wave, ECHONET, KNX, and Bluetooth®.

Alternatively, the communication standard threshold detector 736 may use either the communication standard threshold or the communication standard battery threshold.

The communication standard threshold detector 736 triggers the address tagger 738 through a connection 790. The address tagger 738 tags the IN-TRANSFORMATION message 2100 with the unique device ID (2106, 2108, 2110) of DEST_ADDRESS 0 to N field as determined by the communication standard threshold detector 732. The result computed by the communication standard threshold detector 736 is retrieved, IN_TRANS_STATE 2104 is set to broadcast/multicast or unicast transmission. The address tagger 738 then invokes the state switcher 756 passing the IN-TRANSFORMATION message 2100 through a bus connection 774.

The state switcher 756 is a structural element for making a final decision, in the determining unit 104 including the multiple evaluators in parallel, by integrating the outputs from the evaluators. The state switcher 756 has the option to invoke the message constructor 758 through a connection 793.

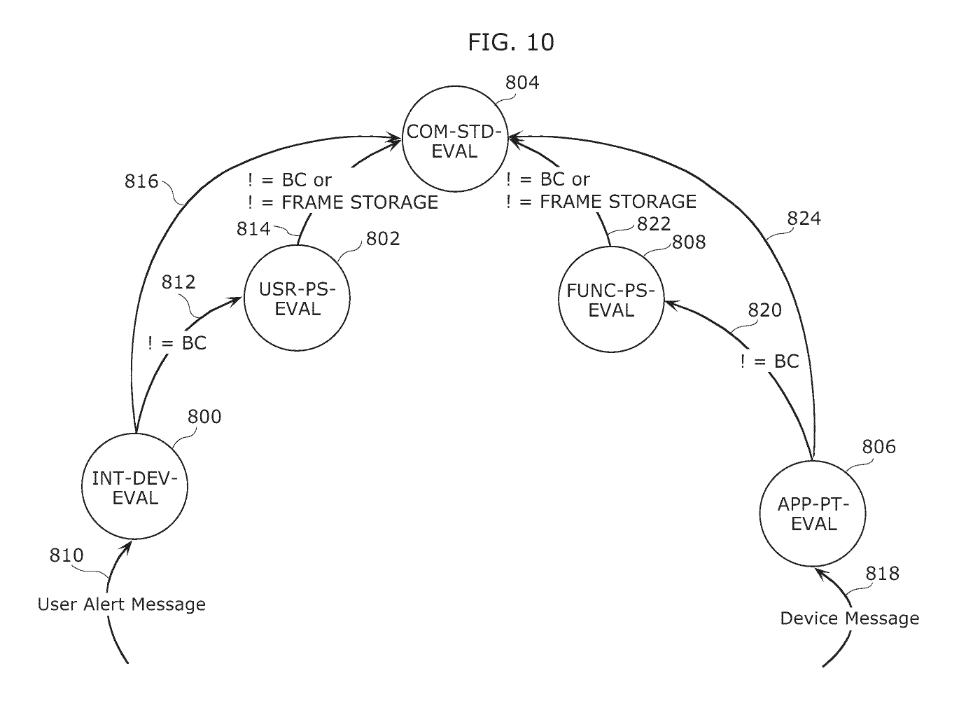

FIG. 10 illustrates the state diagram of the state switcher 756 that determines transition of internal states (800, 802, 804, 806, 808) each using the corresponding evaluator. The state transition must begin with INT-DEV-EVAL 800 or APP-PT-EVAL 806 based on the message type. The state transition can end at any states (800, 802, 804, 806, 808). In the case where there are possible paths of transition, the longest path to the destination is selected to achieve better outcome since more filtering is performed.

For example, assume that the IN-TRANSFORMATION message 2100 with MSG_PAYLOAD 2102 that contains a user alert message 810 is directed into INT-DEV-EVAL (700, 800). If the output of IN_TRANS_STATE 2104 in the IN-TRANSFORMATION message 2100 from INT-DEV-EVAL (700, 800) is broadcast/multicast transmission, a connection 816 for transitioning to COM-STD-EVAL (716, 804) is selected. Else, a connection 812 for transitioning to USR-PS-EVAL (708, 802) is selected.

The USR-PS-EVAL (708, 802) transitions to COM-STD-EVAL (732, 804) through a connection 814 if the output of IN_TRANS_STATE 2104 in the IN-TRANSFORMATION message 2100 is not broadcast/multicast transmission or the IN-TRANSFORMATION message 2100 is not stored in the frame storage 740.

On the other hand, assume that IN-TRANSFORMATION message 2100 with MSG_PAYLOAD 2102 that contains a device message 818 is directed into APP-PT-EVAL (716, 806). In the internal state APP-PT-EVAL (716, 806), a connection 824 for transitioning to COM-STD-EVAL (716, 804) is selected if IN_TRANS_STATE 2104 in the IN-TRANSFORMATION message 2100 indicates broadcast/multicast transmission. Else, a connection 820 for transitioning to FUNC-PS-EVAL (724, 808) is selected. The FUNC-PS-EVAL (724, 808) transitions to COM-STD-EVAL (732, 804) through a connection 822 if IN_TRANS_STATE 2104 in the IN-TRANSFORMATION message 2100 indicates broadcast/multicast transmission or the IN-TRANSFORMATION message 2100 is not stored in the frame storage 740.

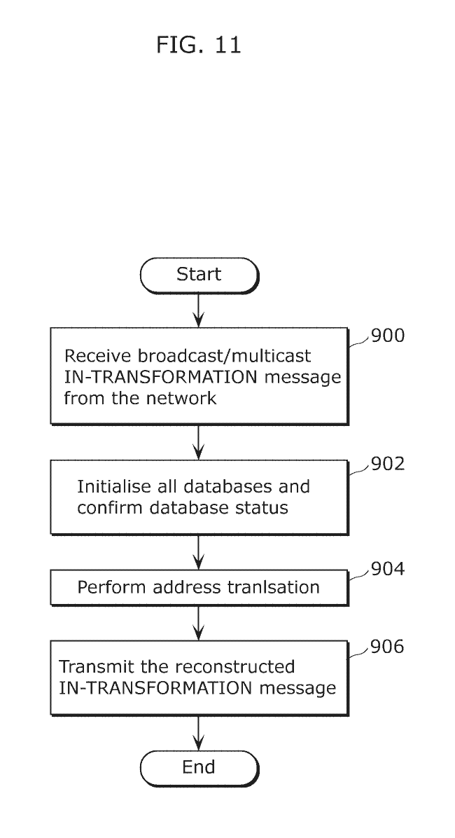

The basic process flow for the overall apparatus is shown in FIG. 11. Once the massage parser 752 receives an IN-TRANSFORMATION message 2100 through a connection 760 as described by Step 900, all database are initialized with confirmed status, (Step 902). After which, the entities (700, 708, 716, 724, 732) begins to perform address translation, (Step 904). Once the IN-TRANSFORMATION message has been padded, the IN-TRANSFORMATION message 2100 is reconstructed by the message constructor 758 before transmission through a connection 794.

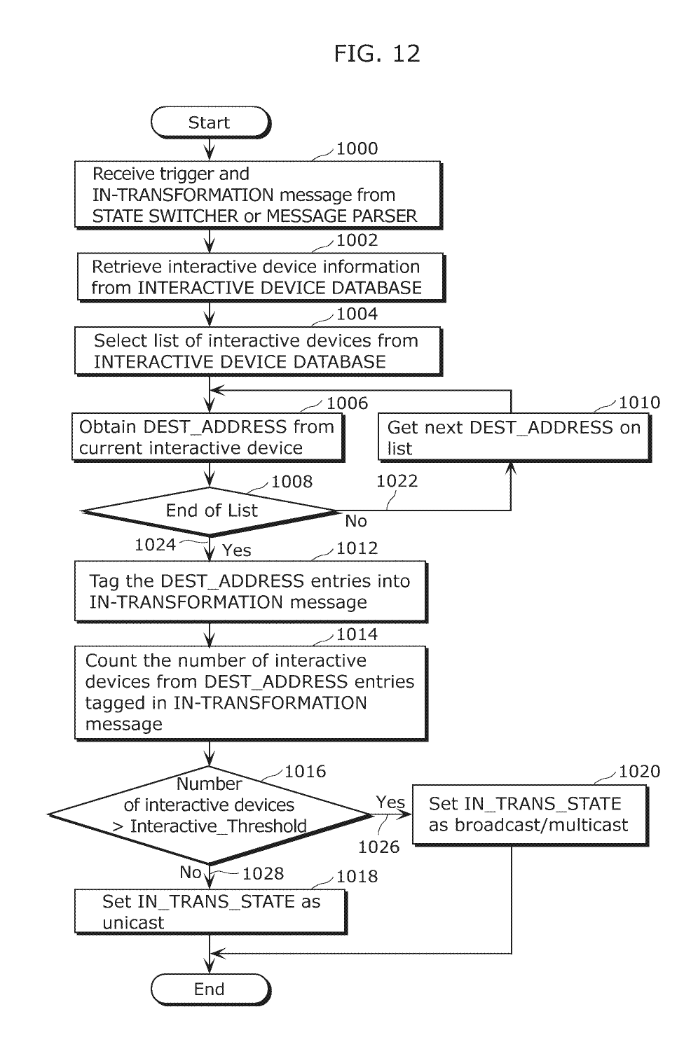

FIG. 12 illustrates a more detailed process performed by the interactive device evaluator 700. This process starts off by receiving a trigger message containing the IN-TRANSFORMATION message on the database retriever (302, 702) from the state switcher 756 or the message parser (310, 752), (Step 1000).

The database retriever (302, 702) retrieves the interactive device information (1500, 1502) from the interactive device database (308, 742) into a list, (Step 1002).

A query is performed on the list to ensure only the interactive devices remain as described in Step 1004. For each record on the list, its corresponding Unique_Device_ID 1500 is extracted, (Step 1006, Step 1008, Step 1022, Step 1010). Upon the end of list with condition (Step 1008), path is taken (Step 1024). At Step 1012, the extracted Unique_Device_ID is tagged into DEST_ADDRESS (2106, 2108, 2110) in the IN-TRANSFORMATION message 2100 by the address tagger (304, 704). The address tagger (304, 704) invokes the interactive threshold detector (306, 706) and counts the number of entries of DEST_ADDRESS (2106, 2108, 2110) in the IN-TRANSFORMATION message 2100, (Step 1014). The number of entries signifies the number of interactive devices that are present. Next, a comparison is performed on the number of entries with the Interactive_Threshold taken from the memory 204, (Step 1016). If the condition 1016 at Step 1016 is true (Yes at Step 1016, Step 1026), IN_TRANS_STATE 2104 of the IN-TRANSINFORMATION message 2100 is set as broadcast/multicast transmission, (Step 1020). Else (No at Step 1016, Step 1028), IN_TRANS_STATE 2104 in the IN-TRANSFORMATION message 2100 is set to unicast, (Step 1018).

Thus, this means that if the number of interactive devices surpasses the Interactive_Threshold, it is more energy efficient to broadcast/multicast to wake up all sleeping terminal devices than to unicast to each of the sleeping terminal devices.

FIG. 13 illustrates a more detailed process performed by the user presence evaluator (408, 708). This process starts off by receiving a trigger message containing the IN-TRANSFORMATION message 2100 on the database retriever (410, 710) from the state switcher 756 or the message parser (422, 752), (Step 1100).

The database retriever (410, 710) retrieves Unique_Device_ID, Last_User_Interacted_Date, Last_User_Interacted_Time, Device_Status (1600, 1602, 1604, 1606 in FIG. 18) from the user presence database (420, 744) with records of Online or No_Status into a list, (Step 1102, Step 1104).

The database retriever (410, 710) sends a query about the system current time at Step 1106. The database retriever (410, 710) also invokes the user presence threshold detector (412, 712).

For each DEST_ADDRESS (2106, 2108, 2110 in FIG. 23) contained in the IN-TRANSFORMATION message 2100, the user presence evaluator (408, 708) determines whether or not there is a terminal device which has Device_Status of Online or No_Status and the matching Unique_Device_ID, (Step 1108). If the condition (Step 1108) is false, a path (No at Step 1108, Step 1126) is taken. Then, the current time is subtracted by Last_User_Interacted_Date 1602 and Last_User_Interacted_Time 1604 of DEST_ADDRESS (2106, 2108, 2110) to determine whether or not the difference is beyond the User_Presence_Threshold, (Step 1110). If the condition (Step 1110) is true, a path (Yes at Step 1110, Step 1130) is taken. The address untagger (414, 714) untags the DEST_ADDRESS (2106, 2108, 2110) from the IN-TRANSFORMATION message 2100, (Step 1112). If the condition at Step 1108 is true (Step 1124), the condition at Step 1110 is false (Step 1128) or the condition at Step 1114 is false (Step 1132), the next DEST_ADDRESS (2106, 2108, 2110) is obtained (Step 1116) until the condition at Step 1114 is true (Step 1134).

After the untagging process, the address untagger (414, 714) checks if there are at least one DEST_ADDRESS (2106, 2108, 2110) in the IN-TRANSFORMATION message 2100. If the condition (Step 1118) is true (Step 1136), IN_TRANS_STATE 2104 is set to broadcast/multicast transmission or the IN-TRANSFORMATION message 2100 is stored in the frame storage (416, 740) through a connection (450, 792), (Step 1122). If the condition (Step 1118) is false (Step 1138), the address untagger (414, 714) sets IN_TRANS_STATE 2104 to unicast.

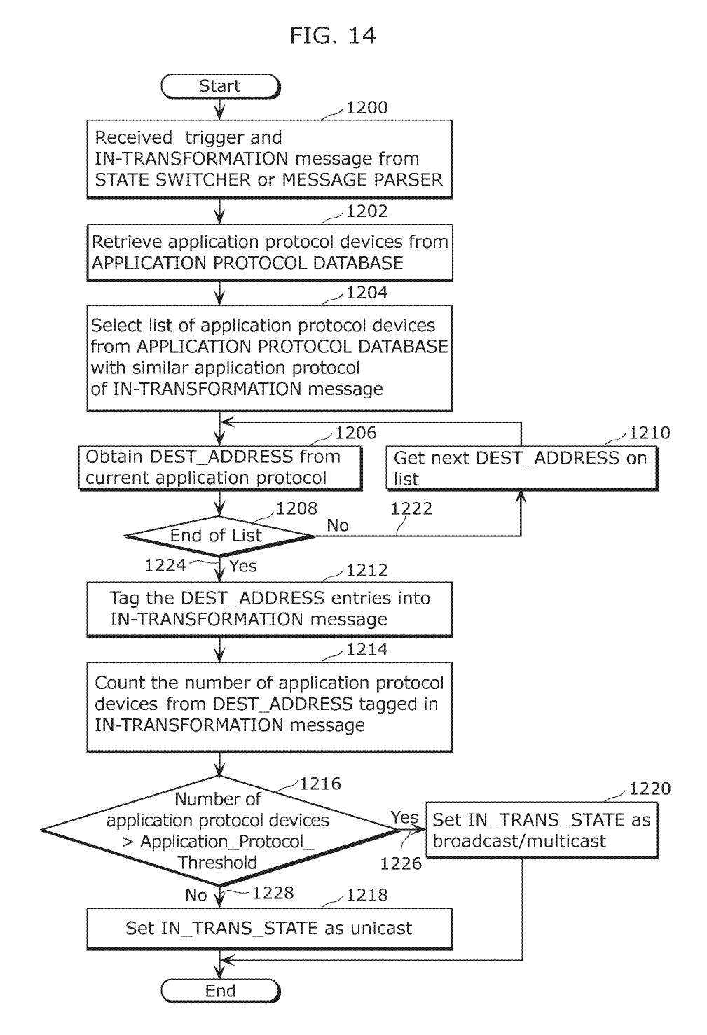

FIG. 14 illustrates a more detailed process performed by the application protocol evaluator 716. This process starts off by receiving a trigger message containing the IN-TRANSFORMATION message on the database retriever (502, 718) from the state switcher 756 or the message parser (510, 752), (Step 1200). The database retriever (502, 718) retrieves the Unique_Device_ID 1700 and Application_Protocol 1702 from the application protocol database (508, 746) into a list, (Step 1202). At Step 1204, a query is performed on the list to ensure only matching application protocol of IN-TRANSFORMATION message 2100 remains.

Next, the application protocol evaluator 716 extracts the corresponding Unique_Device_ID 1700 for each record on the list (Step 1206, Step 1208, Step 1222, Step 1210). When the end of list is reached (Yes at Step 1208, Step 1224), the extracted Unique_Device_ID 1700 is tagged into DEST_ADDRESS (2106, 2108, 2110) in the IN-TRANSINFORMATION message 2100 by the address tagger (504, 720) as Step 1212.

The address tagger (504, 720) invokes the application protocol threshold detector (506, 722) and counts the number of entries of DEST_ADDRESS (2106, 2108, 2110) in the IN-TRANSFORMATION message 2100, (Step 1214). The number of entries signifies the number of application protocol devices that are present.

Then, the application protocol evaluator 716 compares the number of entries with the Application_Protocol_Threshold obtained from the memory 204, (Step 1216). If the condition (Step 1216) is true (Step 1226), IN_TRANS_STATE 2104 of the IN-TRANSINFORMATION message 2100 is set to broadcast/multicast transmission, (Step 1220). Else (No at Step 1216, Step 1228), the application protocol evaluator 716 sets IN_TRANS_STATE 2104 in the IN-TRANSFORMATION message 2100 to unicast, (Step 1218).

Thus, if the number of interactive devices surpasses the Application_Protocol_Threshold, multi-address transmission, such as broadcasting/multicasting, to wake up all sleeping devices is selected instead of unicasting to each of the sleeping devices. It is because multi-address transmission is better for energy efficiency when there are many terminal devices.

FIG. 15 illustrates a more detailed process performed by the user presence evaluator (610, 724). This process starts off by receiving a trigger message containing the IN-TRANSFORMATION message 2100 on the database retriever 726 from the state switcher 756 or the message parser (622, 752), (Step 1300).

The Database Retriever (610, 726) retrieves Source_Unique_Device_ID (1800 in FIG. 20), Function_Related_Device_ID_1 (1802 in FIG. 20), Function_Related_Device_ID_2 (1804 in FIG. 20), Function_Related_Device_ID_N (1808 in FIG. 20) from the device functionality database (620, 748) into a list, (Step 1302).

The database retriever (610, 726) invokes the device/service functionality mapper (612, 728). For each DEST_ADDRESS (2106, 2108, 2110) in the IN-TRANSFORMATION message 2100, the source of message corresponds to Source_Unique_Device_ID 1800. The functionality presence evaluator (610, 724) checks if there is a matching Function_Related_Device_Id_[1 to n] (1802, 1804, 1808), (Step 1304). If the condition (Step 1304) is false (Step 1320), the address untagger (614, 730) untags the DEST_ADDRESS (2106, 2108, 2110) from the IN-TRANSFORMATION message 2100, (Step 1306). If the condition (Step 1304) is true (Step 1318), the next DEST_ADDRESS (2106, 2108, 2110) is obtained (Step 1310).

Also, if the condition (Step 1308) is false (Step 1322), the next DEST_ADDRESS (2106, 2108, 2110) is obtained (Step 1310).

After the untagging process, the address untagger (614, 730) checks if there are at least one DEST_ADDRESS (2106, 2108, 2110) in the IN-TRANSFORMATION message 2100. If there is no DEST_ADDRESS (Yes at Step 1312, Step 1326), IN_TRANS_STATE (2104 in FIG. 23) is set to broadcast/multicast transmission. Alternatively, the IN-TRANSFORMATION message 2100 is stored in the frame storage (416, 740) through a connection (650, 792), (Step 1316). If there are at least one DEST_ADDRESS (No at Step 1312, Step 1328), the address untagger (614, 730) sets IN_TRANS_STATE 2104 to unicast.

FIG. 16 illustrates a more detailed process performed by the communication standard evaluator 732. This process starts off by receiving a trigger message containing the IN-TRANSFORMATION message on the database retriever 734 from the state switcher 756 or the message parser 752, (Step 1400).

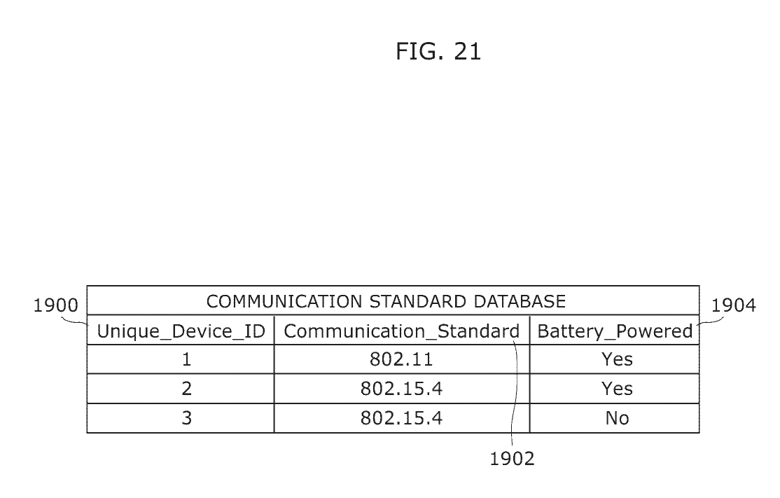

The database retriever 734 retrieves the Unique_Device_ID (1900 in FIG. 21) and Communication_Standard (1902 in FIG. 21) from the communication standard database 750 into a list, (Step 1402). The database retriever 734 invokes the communication standard threshold detector 736 and counts the number of entries of DEST_ADDRESS (2106, 2108, 2110) in the IN-TRANSFORMATION messages 2100, (Step 1404). The number of entries signifies the number of terminal devices that are present. The communication standard threshold detector 736 determines whether each of the terminal devices is mapped to a single communication standard, (Step 1404). If the condition is true (Yes at Step 1404, Step 1420), IN_TRANS_STATE 2104 in the IN-TRANSFORMATION message 2100 is set to unicast, (Step 1408). If the condition is false (No at Step 1404, Step 1422), the entries of DEST_ADDRESS (2106, 2108, 2110) is grouped based on each list of Communication_Standard, (Step 1406). At Step 1406, each member in the list of Communication_Standard shall have a new IN-TRANSFORMATION message 2100 format.

The communication standard evaluator 732 determines, for each Communication_Standard until the end of list (Step 1416, Step 1428, Step 1418), whether or not the number of DEST_ADDRESSes surpasses the Communication_Protocol_Threshold obtained from the memory 204, (Step 1410). As a result of the determination, when the number of DEST_ADDRESSes fails to surpass the Communication_Protocol_Threshold (No at Step 1410, Step 1426), IN_TRANS_STATE 2104 in the IN-TRANSFORMATION message 2100 is set to unicast, (Step 1414).

When the number of DEST_ADDRESSes surpasses the Communication_Protocol_Threshold (Yes at Step 1410, Step 1424), an additional comparison is made to check if the number of BAT_DEV, battery devices, is greater than the Communication_Protocol_Battery_Threshold, (Step 1432). The Communication_Protocol_Battery_Threshold 1432 is retrieved from the memory 204. BAT_DEV is derived from the number of battery powered devices as indicated in the Battery_Powered (1904 in FIG. 21) field from the communication standard database 750 with regards to the current parameter it is comparing against.

For example, in the case of the communication standard evaluator 732, the total number of devices with Battery_Powered 1904 set to Yes and the same Communication_Standard 1902 is defined as BAT_DEV. In the case of the user presence evaluator (408, 708), the total number of devices with Battery_Powered 1904 set to Yes and the user presence fields (1602, 1604, 1606) containing an operation history during the predetermined time period is defined as BAT_DEV. If the condition at Step 1432 is true (Step 1436), IN_TRANS_STATE 2104 in the IN-TRANSFORMATION message 2100 is set to unicast transmission, (Step 1414). Else, if the condition at Step 1432 is false (Step 1434), IN_TRANS_STATE 2104 in the IN-TRANSFORMATION message 2100 is set to broadcast/multicast transmission, (Step 1412).

Note that the condition at Step 1432 can be added to each of Step 1026, Step 1136, Step 1226, and Step 1326. Step 1432 is designed to promote unicast transmission in order to sustain longer battery life on battery powered devices. When the end of list is reached (Yes at Step 1416, Step 1430), the processing is terminated.

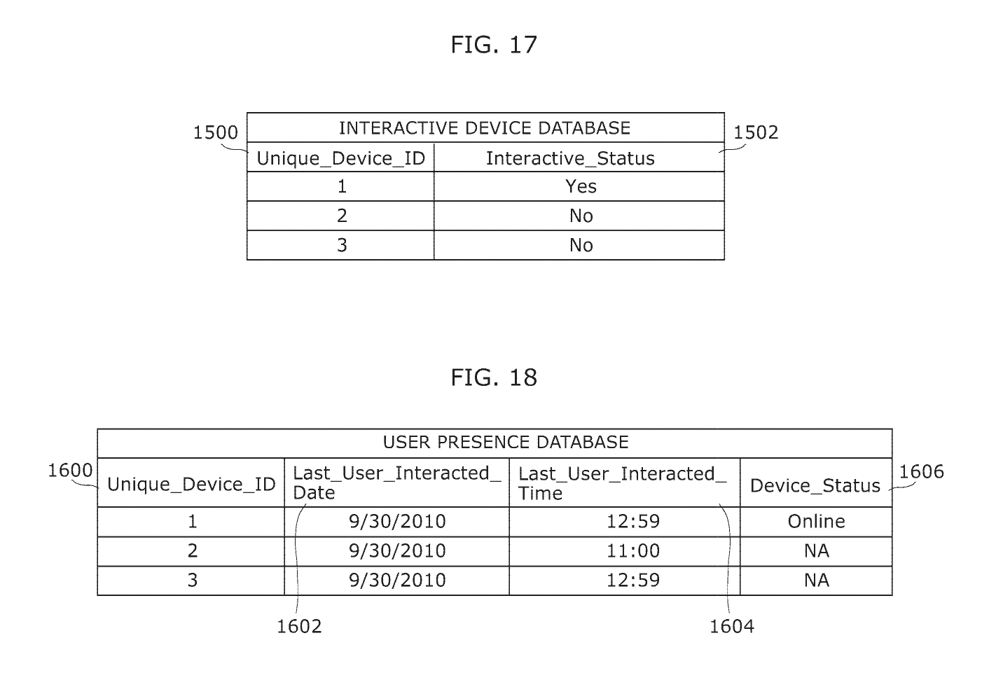

FIG. 17 illustrates the exemplary content of the interactive device database (308, 418, 742) of the interactive device evaluator (300, 400, 700). This database contains two fields, Unique_Device_ID 1500 and Interactive_Status 1502. Note that, with reference to FIG. 17 to FIG. 21, any one of Unique_Device_ID 1500, Unique_Device_ID 1600, Unique_Device_ID 1700, Source_Unique_Device_ID 1800, and Unique_Device_ID 1900 defines a primary key that is unique throughout the relational database.

Interactive_Status 1502 defines whether the terminal device can interact with human. For example, when the terminal device has a display unit, Interactive_Status 1502 is set to Yes. On the other hand, when the terminal device has no display unit, Interactive_Status 1502 is set to No.

FIG. 18 illustrates the exemplary content of the user presence database (420, 744) of the user presence evaluator (408, 708). This database contains four fields, Unique_Device_ID 1600, Last_User_Interacted_Date 1602, Last_user_Interacted_Time 1604 and Device_Status 1606.

Last_User_Interacted_Date 1602 defines the last date when the terminal device interacted with the user. In other words, it defines the date when the last user's operation was accepted. Last_User_Interacted_Date 1604 defines the last time when the terminal device interacted with the user. In other words, it defines the time when the last user's operation was accepted. Device_Status 1606 defines the device status of the terminal device. Any status can be used. In particular, the status includes status for instant messenger, status on the operating mode, and status on the power level for energy saving. For example, for the status for instant messenger, records of Device_Status 1606 can be set to Online, Busy, Not Applicable (NA), or the like. Online refers to the internal device status on whether the interaction between the user and device has expired. Busy refers to the internal device status on stating that the user is present but is only interested if the message is important. NA refers to devices such as washing machine that does not support Device_Status feature.

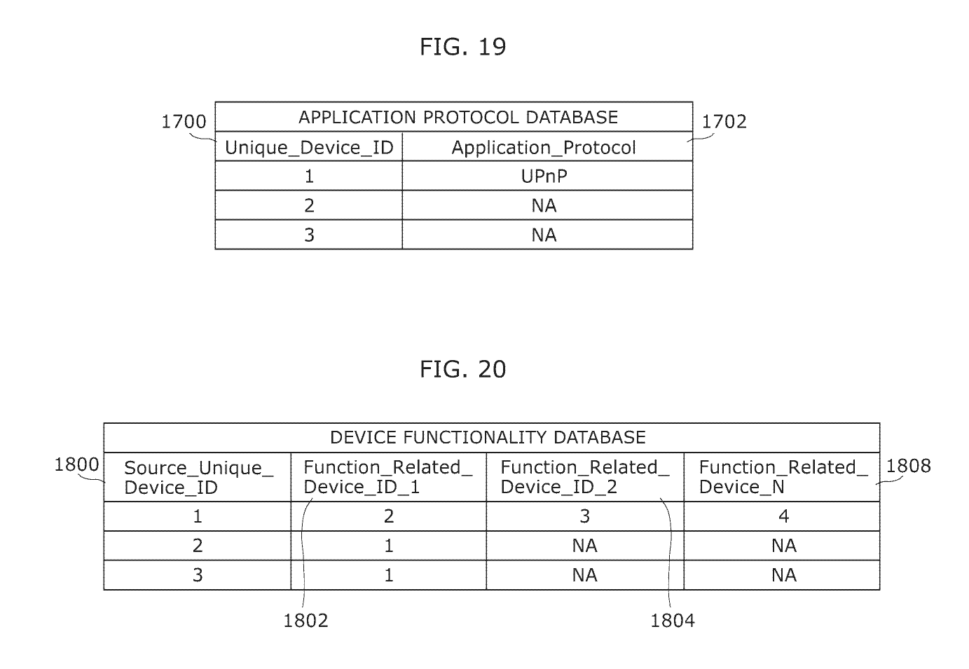

FIG. 19 illustrates the exemplary content of the application protocol database (508, 618, 746) of the application protocol evaluator (500, 600, 716). This database contains two fields, Unique_Device_ID 1700 and Application_Protocol 1702.

Application_Protocol 1702 defines the protocol supported by the terminal device. The protocol can be Universal Plug and Play (UPnP) for example, but not limited to it.

FIG. 20 illustrates the exemplary content of the device functionality database (620, 748) of the functionality presence evaluator (608, 724). This database contains two fields, Unique_Device_ID 1800 and Function_Related_Device_ID_[1 to N] (1802, 1804, 1808). Note that Function_Related_Device_ID_[1 to N] may be in the form of a linked list with N members for example. In addition, the functionality relationship is not limited to a relationship of a single functionality For example, the terminal device having the functionality relationship may be identified by combination of the functionalities.

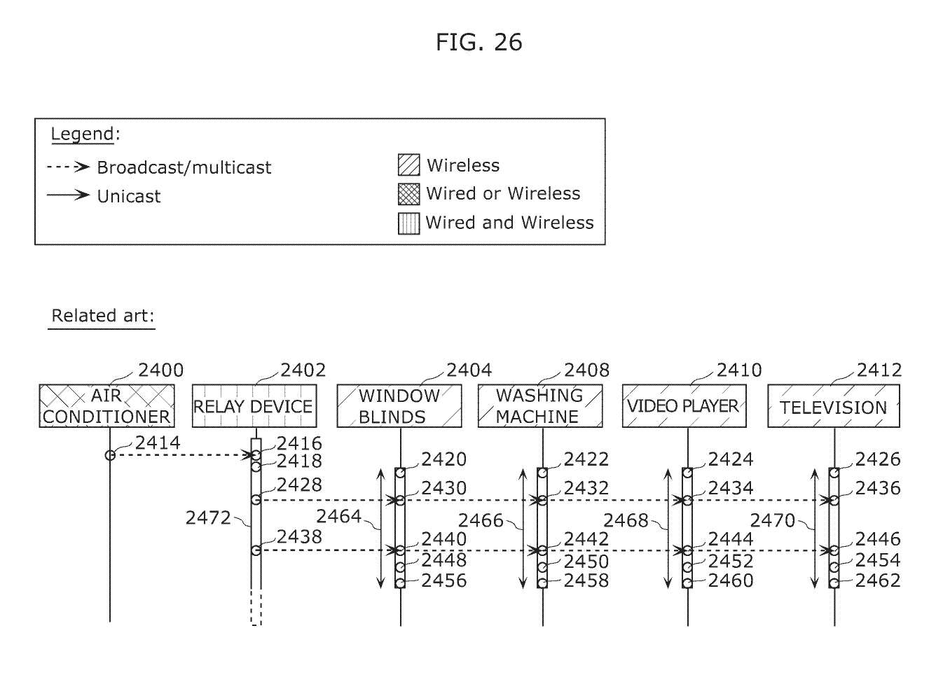

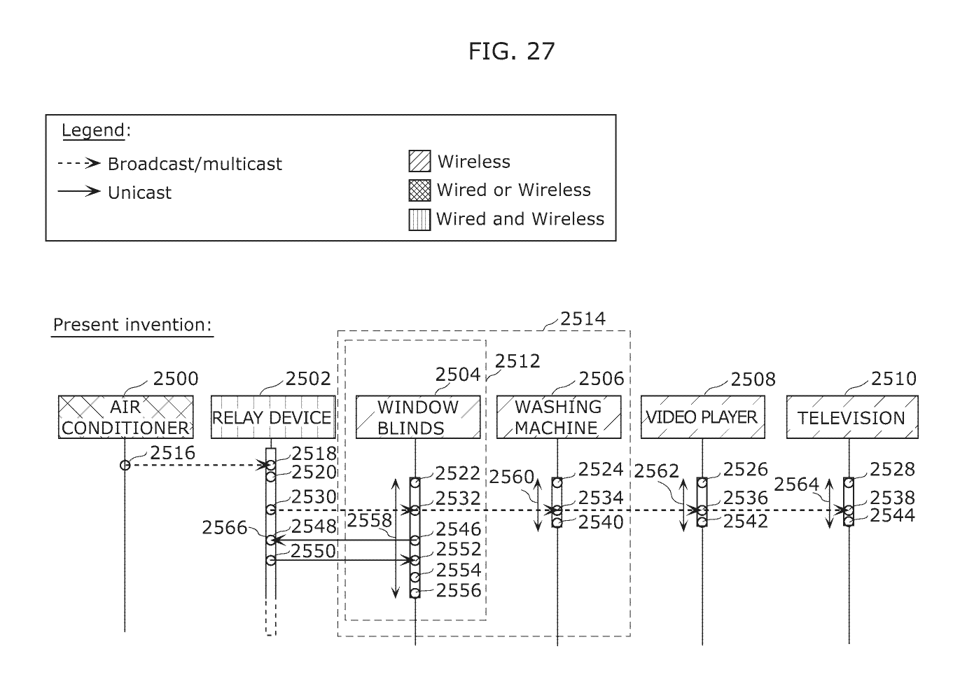

Function_Related_Device_ID_[1 to N] (1802, 1804, 1808) defines a linked list of destination devices which have functionality relationship with the source node. Example case can be seen in FIG. 26 and FIG. 27 where the air conditioner (2400, 2500) has functionality relationship with the window blinds (2404, 2504) but not the washing machine (2408, 2506) in terms of home temperature regulation. Thus, when Source_Unique_Device_ID indicates the air conditioner, Functional_Related_Device_ID_1 is set to the ID of the window blinds. In addition, when there is no other terminal device having functionality relationship with the air conditioner, Functional_Related_Device_ID_[2 to N] is set to NA.

FIG. 21 illustrates the content of the communication standard database 750 of the communication standard evaluator 732. This database contains three fields, Unique_Device_ID 1900, Communication_Standard 1902, and Battery_Powered 1904.

Communication_Standard 1902 defines whether the Layer 1 or Layer 2 protocol is used by the device. Any protocols can be used, but they include 802.15.4, 802.11, and Ethernet®.

Battery_Powered 1904 defines whether the terminal device is running on limited energy supply. The terminal device running on limited energy supply includes, but not limited to, the terminal device driven by primary battery or secondary battery. For example, the terminal device is possible which has the predetermined target value of power consumption to save energy. Battery_Powered 1904 field can also exist in other databases (742, 744, 746, 748) of the relay device 100.

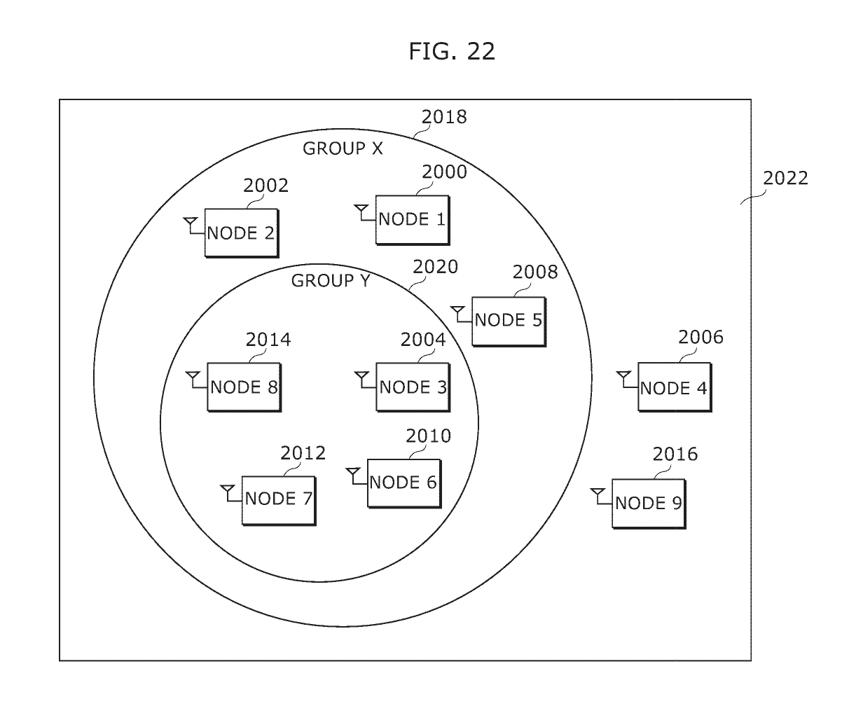

FIG. 22 illustrates a Venn diagram for mutual relations among nodes (2000, 2002, 2004, 2006, 2008, 2010. 2012, 2014, 2016) which are the terminal devices in the network 2022. Group X 2018 includes node1 (2000), node2 (2002), node3 (2004), node5 (2008), node6 (2010), node7 (2012) and node8 (2014). In addition, node3 (2004), node6 (2010), node7 (2012) and node8 (2014) also belong to Group Y 2020. Node4 (2006) and node9 (2016) do not belong to Group X 2018 and Group Y 2020.

For example, Group X 2018 can be considered as interactive device presence grouping or application protocol presence grouping. Group Y 2020 can be considered as user presence grouping or functionality presence grouping. Nodes are not limited to one group; the same node for this case (2004, 2010, 2012, 2014) can be presented in plurality of grouping. In this case, node 4 (2006) and node 9 (2016) do not fall under any of the grouping. Group X 2018 has a larger scope and can target more nodes compare to Group Y 2020. Group Y is narrowing down the scope to limited target nodes only.

FIG. 23 illustrates the IN-TRANSFORMATION message 2100 format. The IN-TRANSFORMATION message 2100 includes three main fields, MSG_PAYLOAD 2102, IN_TRANS_STATE 2104, DEST_ADDRESS 0 to N (2106, 2108, 2110).

MSG_PAYLOAD 2102 contains information included in the message that the relay device 100 receives from the source device.

IN_TRANS_STATE 2104 contains information on whether the IN-TRANSFORMATION message 2100 is transmitted as multi-address transmission or unicast transmission. Once the address untagger (714, 730) or the address tagger (704, 720, 738) sets IN_TRANS_STATE 2104 to information indicating multi-address transmission (for example, broadcast/multicast transmission), the control device 100 ignores the information set in DEST_ADDRESS 0 to N (2106, 2108, 2110) and IN_TRANS_STATE. DEST_ADDRESS 0 to N (2106, 2108, 2110) and IN_TRANS_STATE are removed by the message constructor 758 before transmission.

When IN_TRANS_STATE 2104 is set to information indicating unicast transmission, each DEST_ADDRESS 0 to N (2106, 2108, 2110) is converted to unicast frame based on the destination protocol standard by the translating unit 106 before transmission.

DEST_ADDRESS 0 to N (2106, 2108, 2110) contains Unique_Device_IDs that are tagged by the address tagger (706, 722, 738) or untagged by the address untagger (714, 730).

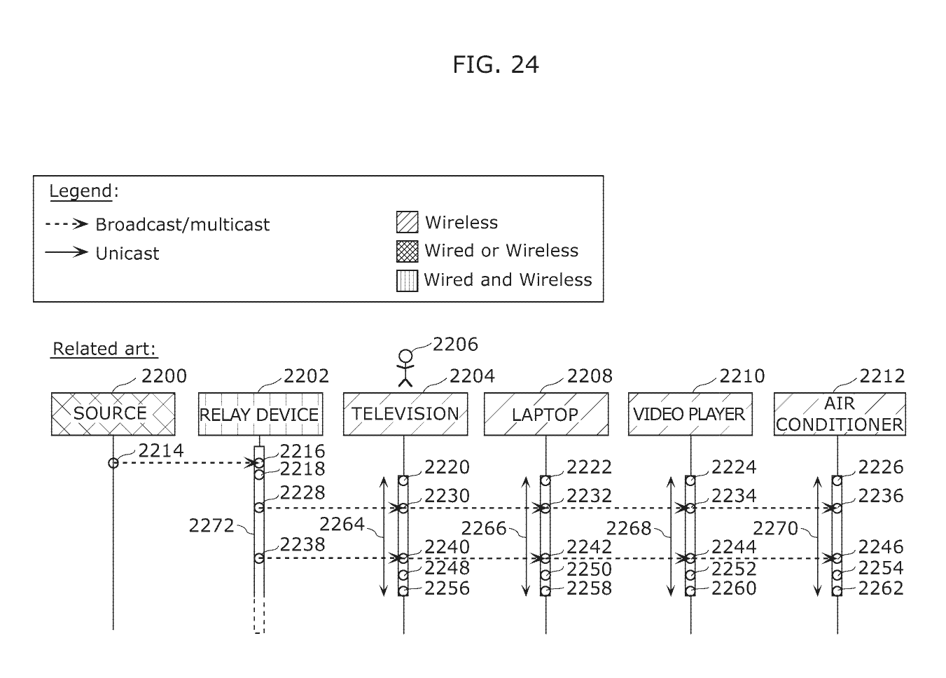

With reference to FIG. 24 to FIG. 29, the following paragraphs will describe in detail the difference between the control device 100 according to the present embodiments and the relay device according to the related art of the present invention. Note that, in FIG. 24 to FIG. 29, the relay device sends the beacon frame to the terminal device prior to transmission of the message, and the terminal device received the beacon frame obtains the multi-address message from the relay device at a specified timing. In other words, the relay device recognizes this as pull-based multi-address transmission by the terminal device. However, the present invention may also be applicable to push-based multi-address transmission in which the relay device transmits the multi-address message to the terminal devices.

FIG. 24 illustrates a use case scenario of the relay device when the multi-address message transmitted from a source node 2200 is relayed by the relay device 2202 according to the related art of the present invention. In this scenario, there are the source node 2200—rice cooker, the relay device 2202 according to the related art, and four sleeping wireless nodes, namely a television 2204, a laptop 2208, a video player 2210 and an air conditioner 2212. The multi-address message to be relayed by the relay device 2202 is assumed to be useful to only the terminal devices which are interactive devices with display units and near each of which a user is present.

The source node 2200 may originate from sleeping wireless nodes (2204, 2208, 2210, 2212). The user 2206 is watching the television 2204. The relay device 2202 is always awake, (Time 2272). The source node 2200—rice cooker sends broadcast/multicast user alert message to inform that the cooking has completed, at Step 2214. The broadcast/multicast message is received by the relay device 2202 at Step 2216. The relay device 2202 buffers the broadcast/multicast message received and flags the pending field of next beacon frame, (Step 2218). At Step 2220, Step 2222, Step 2224, and Step 2226, the sleeping wireless terminal device (2204, 2208, 2210, 2212) wakes up at a pre-informed time by the last beacon frame and awaits for the next beacon frame to be transmitted from the relay device 2202. At Step 2228, the beacon frame is broadcasted/multicasted to all devices and received accordingly at Step 2230, Step 2232, Step 2234, and Step 2236.

The beacon frame contains the pending frame field informing all recipient devices (2204, 2208, 2210, 2212) of an incoming broadcast/multicast. The relay device 2202 transmits the buffered broadcast/multicast message at Step 2238. Then, the broadcast/multicast message is received by all recipient devices (Step 2240, Step 2242, Step 2244, Step 2246). The received broadcast/multicast message by the source node (2204, 2208, 2210, 2212) is parsed at (Step 2248, Step 2250, Step 2252, Step 2254). In this case, only the television 2204 and the laptop 2208, which are interactive devices, handle the received broadcast/multicast message. Then, the terminal device (2204, 2208, 2210, 2212) schedules for the next wakeup and goes back to sleep at Step 2256, Step 2258, Step 2260, and Step 2262. Therefore, the wakeup time on terminal devices (2204, 2208, 2210, 2212) are Time 2264, Time 2266, Time 2268, and Time 2270, respectively, without regards on whether the received message content is useful to themselves.

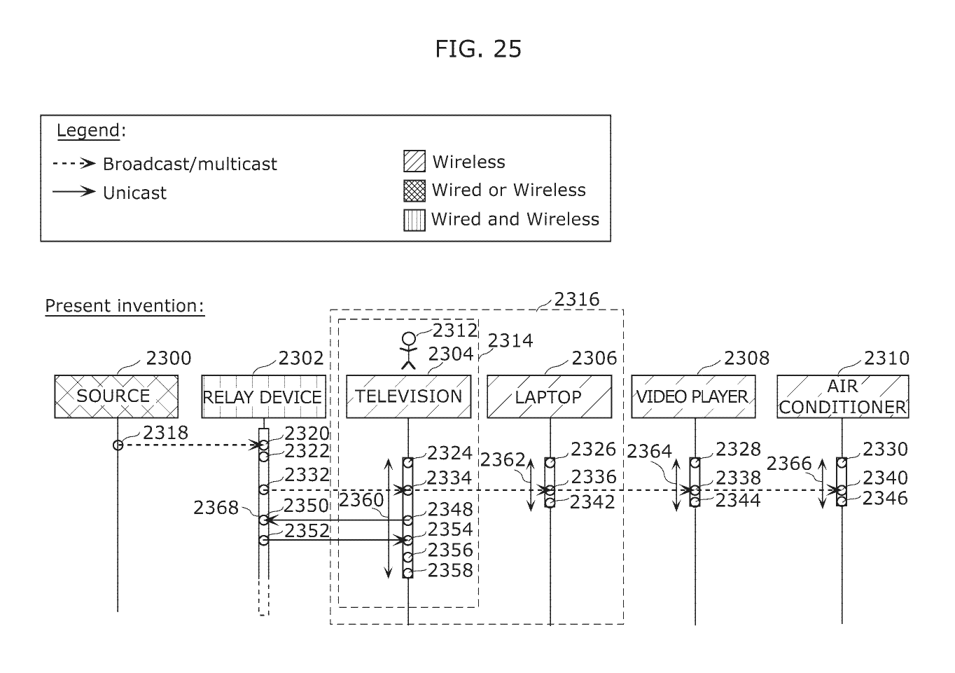

On the other hand, FIG. 25 illustrates a use case scenario in which the same multi-address message as the scenario of FIG. 24 is relayed by the control device according to an embodiment of the present invention with the interactive device evaluator 700 and the user presence evaluator 708. Same labels and description between FIG. 24 and FIG. 25 are (2200, 2300), (2204, 2304), (2208, 2306), (2210, 2308), (2212, 2310), (2214, 2318), (2216, 2320), (2220, 2324), (2222, 2326), (2224, 2328), (2226, 2330), (2256, 2358), (2258, 2342), (2260, 2344), (2262, 2346), (2272, 2368).

The relay device 2302 which is the control device with the interactive device evaluator 700 and the user presence evaluator 708 categorizes the television 2304 and the laptop 2306 as the interactive devices 2316. Furthermore, the relay device 2302 categorizes the television 2304 as the terminal device 2314 near which the user 2312 is present. At Step 2322, the interactive device evaluator 700 and the user presence evaluator 708 set the flag of the pending field contained in the next beacon to unicast for destination devices. The beacon frame is sent via multi-address transmission at Step 2322 and received at Step 2334, Step 2336, Step 2338, and Step 2340. The beacon frame notifies each terminal device that the television 2304 has a unicast message to be transmitted whereas all others (2306, 2308, 2310) do not. Then, the terminal device (2306, 2308, 2310) schedules for the next wakeup and goes back to sleep at Step 2342, Step 2344, and Step 2346. On the other hand, at Step 2348, the television 2304 unicasts a request message to obtain the buffered message from the relay device 2302. Then, at Step 2350, the relay device 2302 receives the request message from the television 2304. At Step 2352, the relay device 2302 responds to the request message from the television 2304 via unicast transmission. Then, at Step 2354, only the television 2304 receives the unicast message. The received message is handled by the television 2304 at Step 2356. Then, the television 2304 schedules for the next wakeup and goes back to sleep.

In this case, the wakeup times on the terminal devices other than the television 2304 (2362, 2364, 2366) are shorter than the Time 2266, Time 2268, or Time 2270 shown in FIG. 24, respectively. In addition, the wakeup time 2360 on the television 2304 may be shorter as compared to broadcast with lower physical data rate at Step 2238. This is because a higher physical data rate, compared to broadcast, can be used for unicast at the transmission (2348, 2352) during Time 2360.

FIG. 26 illustrates a use case scenario of the relay device when the multi-address message transmitted from a source node 2400 is relayed by the relay device 2402 according to the related art of the present invention. In this scenario, there are an air conditioner 2400 which is the source node, a relay device 2402, and four sleeping wireless nodes, namely window blinds 2404, a washing machine 2408, a video player 2410 and a television 2412. In addition, the multi-address message to be relayed by the relay device 2402 is assumed to be useful to only the terminal devices which support UPnP as the application protocol and have a functionality relationship to the source node 2500 that is the air conditioner.

The window blinds 2404 and the washing machine 2408 support the application protocol such as Universal Plug and Play (UPnP). The relay device 2402 is always awake, (Time 2472). The air conditioner 2400 sends broadcast/multicast device message at Step 2414 to update latest device status information. The broadcast/multicast message is received by the relay device 2402 at Step 2416.

The relay device 2402 buffers the broadcast/multicast message received and flags the pending field of next beacon frame, (Step 2418). At Step 2420, Step 2422, Step 2424, and Step 2426, the sleeping wireless terminal device (2404, 2408, 2410, 2412) wakes up and awaits for the beacon frame to be transmitted from the relay device 2402.

At Step 2428, the beacon frame is broadcasted/multicasted to all devices. The beacon frame is received by each terminal device at Step 2430, Step 2432, Step 2434, and Step 2436. The beacon frame contains the pending frame field informing all recipient devices (2404, 2408, 2410, 2412) of an incoming broadcast/multicast. The relay device 2402 transmits the buffered broadcast/multicast message at Step 2438. The broadcast/multicast message is received by all recipient devices (Step 2440, Step 2442, Step 2444, Step 2446).

The received broadcast/multicast message by the terminal device (2404, 2408, 2410, 2412) is parsed at Step 2448, Step 2450, Step 2452, Step 2454. In this case, only the window blinds 2404 understands the semantics of the broadcast/multicast message. The terminal device (2404, 2408, 2410, 2412) schedules for the next wakeup and goes back to sleep at Step 2456, Step 2458, Step 2460, and Step 2462. The wakeup time on terminal devices (2404, 2408, 2410, 2412) are Time 2464, Time 2466, Time 2468, and Time 2470, respectively, without regards on whether the received message content is useful to themselves.

On the other hand, FIG. 27 illustrates a use case scenario in which the same multi-address message as the scenario of FIG. 26 is relayed by the control device according to an embodiment of the present invention with the application protocol evaluator and the functionality presence evaluator. Same labels and description between FIG. 26 and FIG. 27 are (2400, 2500), (2404, 2504), (2408, 2506), (2410, 2508), (2412, 2510), (2414, 2516), (2416, 2518), (2420, 2522), (2422, 2524), (2424, 2526), (2426, 2528), (2456, 2556), (2458, 2540), (2460, 2542), (2462, 2544), (2472, 2566).

The relay device 2502 which is the control device according to the embodiment categorizes the windows blind 2504 and the washing machine 2506 as application protocol devices 2514 and further categorizes the window blinds 2504 as the terminal device 2512 having the functionality related to the source node 2500 which is the air conditioner.

At Step 2520, the application protocol evaluator 716 and the functionality presence evaluator 724 set the flag of the pending field contained in the next beacon to unicast for destination devices. At Step 2530, the beacon frame is broadcasted/multicasted. Then, the beacon frame is received by each terminal device at Step 2532, Step 2534, Step 2536, and Step 2538. The beacon frame notifies that the window blinds 2504 has a buffered unicast message whereas all others (2506, 2508, 2510) does not. The terminal device (2506, 2508, 2510) schedules for the next wakeup and goes back to sleep at Step 2540, Step 2542, and Step 2544.

At Step 2546, the window blinds 2504 unicasts a request message to obtain the buffered message from the relay device 2502. Then, at Step 2548, the relay device 2502 receives the request message from the window blinds 2504. At Step 2550, the relay device 2502 responds to the request message via unicast transmission. Then, at Step 2552, the window blinds 2504 receives the unicast message.

The received message is handled by the window blinds 2504 at Step 2554. After this, at Step 2556, the window blinds 2504 schedules for the next wakeup and goes back to sleep. The wakeup times on Time 2560, Time 2562, and Time 2564 are shorter than Time 2466, Time 2468, and Time 2470 shown in FIG. 26, respectively.

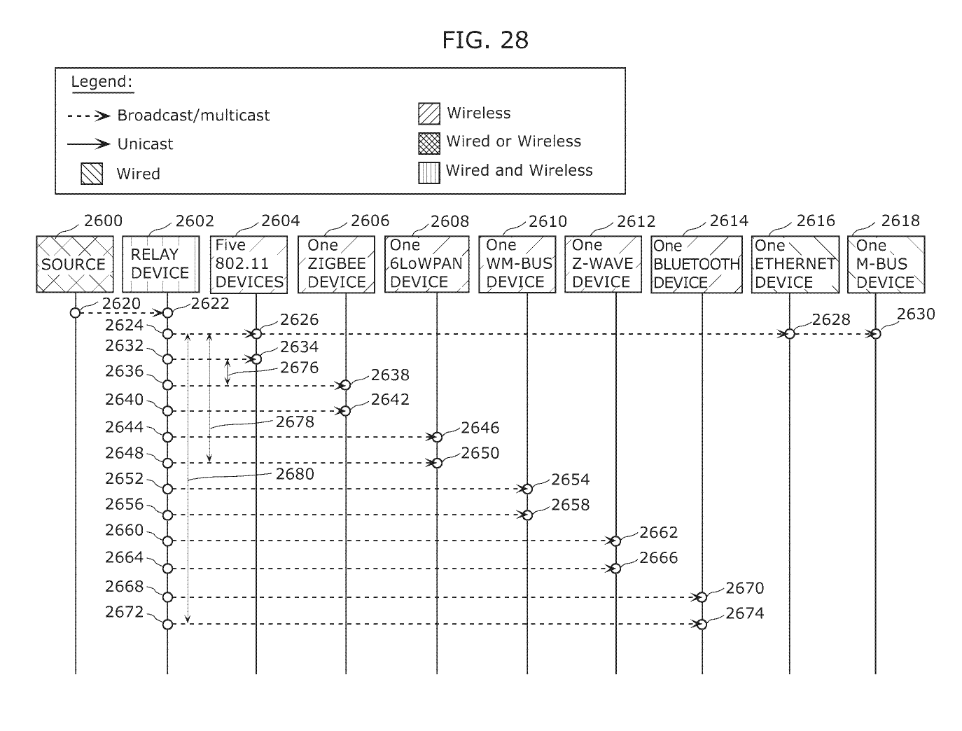

FIG. 28 illustrates a use case scenario of the relay device when the multi-address message transmitted from a source node 2600 is relayed by the relay device 2602 according to the related art of the present invention. In this scenario, there is a source node 2600 which can be a wired or wireless node, a relay device 2602 according to the related art which can be a wired and wireless node, five 802.11-based terminal devices (2604), one ZigBee-based terminal device (2606), one 6LoWPAN-based terminal device (2608), one WM-Bus-based terminal device (2610), one Z-Wave-based terminal device (2612), one Bluetooth-based terminal device (2614), one Ethernet-based terminal device (2616) and one M-Bus-based terminal device (2618).

Note that the multi-address message relayed by the relay device 2602 is assumed to be useful to only the terminal devices supporting 802.11, ZigBee, or 6LoWPAN as the communication standard.

The source node 2600 may be one of the terminal devices which are the sleeping wireless nodes (2604, 2606, 2608, 2610, 2612, 2614) and the terminal devices which are the wired nodes (2616, 2618).

All wireless devices (2602, 2604, 2606, 2608, 2610, 2612, 2614) communicates on the same frequency band. The relay device 2602 is always awake and has a plurality of wired and wireless interfaces. The source node 2600 sends broadcast/multicast device message to update latest device status information at Step 2620.

The broadcast/multicast message is received by the relay device 2602 at Step 2622. The relay device 2602 buffers the broadcast/multicast message received and flags the pending field of next beacon frame for each wireless interface at Step 2624, Step 2636, Step 2644, Step 2652, Step 2660, and Step 2668. At Step 2624, the wired broadcast/multicast message is broadcasted/multicasted to the wired devices. More specifically, at Step 2628, the message is broadcasted/multicasted to the Ethernet device 2616. Similarly, at Step 2630, the message is broadcasted/multicasted to the M-BUS device 2618. At Step 2624, Step 2636, Step 2644, Step 2652, Step 2660, and Step 2668, the beacon frame is broadcasted to all wireless devices (2604, 2606, 2608, 2610, 2612, 2614). Then, the beacon frame is received by each terminal device at Step 2626, Step 2638, Step 2646, Step 2654, Step 2662, and Step 2670. The beacon frame contains the pending frame field informing all terminal devices (2604, 2606, 2608, 2610, 2612, 2614) of an incoming broadcast/multicast. The relay device 2602 transmits the buffered broadcast/multicast message at Step 2632, Step 2640, Step 2648, Step 2656, Step 2664, and Step 2672. Then, the broadcast/multicast message is received by all terminal devices (2604, 2606, 2608, 2610, 2612, 2614) at Step 2634, Step 2642, Step 2650, Step 2658, Step 2666, and Step 2674.

The received broadcast/multicast message by the terminal is parsed by all terminal devices (2604, 2606, 2608, 2610, 2612, 2614, 2616, 2618) without regards on whether the message content is useful. In this scenario, only the five 802.11-based terminal devices (2602), the ZigBee-based terminal device (2606), and 6LoWPAN-based terminal device (2608) understand the semantics of the broadcast/multicast message. Therefore, the message content is useless for the rest of the terminal devices (2610, 2612, 2614, 2616, 2618).

In the scenario shown in FIG. 28, in order to perform broadcast/multicast to all devices, the message delivery latency requires a duration shown as Time 2680. The latency of the terminal devices (2604, 2606, 2608) is shown as Time 2678. With broadcast/multicast's physical data rate, the duration for positive clear channel assessment requires Time 2676.

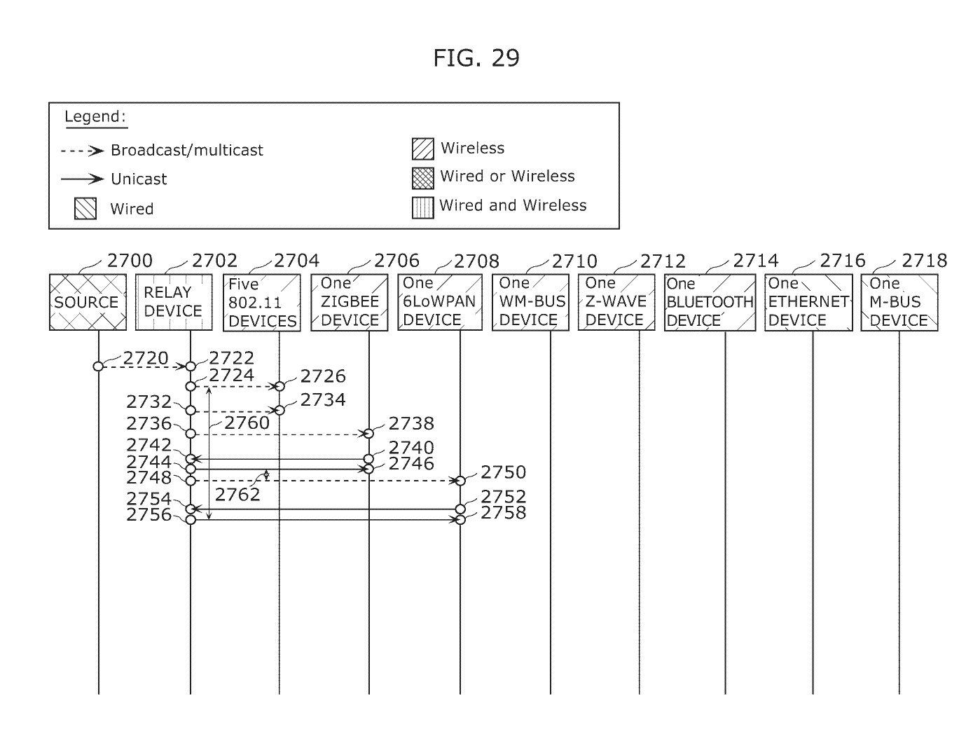

On the other hand, FIG. 29 illustrates a use case scenario in which the same multi-address message as the scenario of FIG. 28 is relayed by the control device according to an embodiment of the present invention with the communication standard evaluator 732. Same labels and description between FIG. 28 and FIG. 29 are (2600, 2700), (2604, 2704), (2606, 2706), (2608, 2708), (2610, 2710), (2612, 2712), (2614, 2714), (2616, 2716), (2618, 2718), (2620, 2720), (2622, 2722).

At Step 2724, the relay device 2702 which is the control device with the communication standard evaluator 732 understands that the semantics of the broadcast/multicast message are intended for only the terminal devices supporting a particular communication standard, namely terminal devices 2704, a terminal device 2706, and a terminal device 2708.

Here, assume Communication_Protocol_Threshold of each communication protocol is set to three at Step 1410. Thus, when at least one of the number of 802.11-based terminal devices, the number of ZigBee-based terminal devices, and the number of 6LoWPAN-based terminal devices exceeds three, the communication standard evaluator 732 instructs to broadcast/multicast to the terminal devices whose total number exceeds three. Here, among the terminal devices 2704, the terminal device 2706, and the terminal device 2708, the total number of terminal devices 2704 are five and exceeds three. Whereas, each of the terminal device 2706 and the terminal device 2708 is still within the threshold. Thus, the message destined for five 802.11-based devices 2704 is sent as a beacon frame at Step 2724. Then, the buffered message is broadcasted/multicasted at Step 2732. On the other hand, each of the terminal devices 2704 receives the beacon frame at Step 2726 and receives the broadcasted/multicasted message from the relay device 2702 at Step 2734.

At Step 2736, a beacon frame for the one ZigBee-based terminal device 2706 is sent. The beacon frame is received by the terminal device 2706 at Step 2738. In response, a request message requesting for transmission of MSG_PAYLOAD 2102 is unicasted by the one ZigBee-based terminal device 2706 at Step 2740. The transmitted request message is received by the relay device 2702 at Step 2742. The relay device 2702 unicasts MSG_PAYLOAD 2102 at Step 2744. The transmitted MSG_PAYLOAD 2102 is received by the one ZigBee-based terminal device 2706 at Step 2746.

At Step 2748, a beacon frame for one 6LoWPAN-based terminal device 2708 is sent. The beacon frame is received by the terminal device 2708 at Step 2750. In response, a request message requesting for transmission of MSG_PAYLOAD 2102 is unicasted by the one 6LoWPAN-based terminal device 2708 at Step 2752. The transmitted request message is received by the relay device 2702 at Step 2754. The relay device 2702 unicasts MSG_PAYLOAD 2102 at Step 2756. The transmitted MSG_PAYLOAD 2102 is received by the one 6LoWPAN-based terminal device 2708 at Step 2758.

A larger unicast data rate can be used at Time 2762 as compared to the broadcast/multicast data rate during Time 2676 in FIG. 28, thus improving in latency. At a whole, the overall latency improvement to complete the delivery of message to intended terminal devices (2704, 2706, 2708) of MSG_PAYLOAD 2102 is indicated by Time 2760. In addition, the terminal devices (2710, 2712, 2714, 2716, 2718) containing communication standards are segregated from the broadcast/multicast message 2720. This leads to improved bandwidth and latency as compared to the terminal devices (2610, 2612, 2614, 2616, 2618) in FIG. 28. Furthermore, converting burst of received broadcast/multicast message into unicast by the relay device 2702 improves latency of message delivery in the case where only a single broadcast is allowed within the wireless power saving superframe structure.

Note that, in FIG. 1, networks A 116 to N 122 are present between source nodes A to N and the relay device 100, respectively, where each of the networks A 116 to N 122 may be an outside network or an in-home network.

Note that, in FIG. 6, FIG. 8, and FIG. 9, an evaluation result from one evaluator is regarded as an input to another evaluator when the address translation entity according to the present embodiments has plural evaluators. For example, with reference to FIG. 6, an output from the interactive threshold detector 406 included in the interactive device evaluator 400 is inputted into the database retriever 410 included in the user presence evaluator 408. In other words, the first evaluator which is one of the evaluators and the second evaluator which is other than the first evaluator are connected in series. However, the evaluators may be connected in parallel. In this case, the address translation entity selects one evaluation result based on a given criterion from among results of determinations by the evaluators. For example, logical disjunction of terminal devices specified as the devices for unicast transmission for each evaluator may be selected as the final specified terminal devices. Alternatively, logical conjunction of terminal devices specified as the devices for unicast transmission for each evaluator may be selected as the final specified terminal devices. Alternatively, when at least one evaluator determines that multi-address transmission is appropriate, multi-address transmission to all the terminal devices is performed.

Thus, the method of implementing the present invention has been described based on the embodiments, but the present invention is not limited to these embodiments. Various modifications to the present embodiments that can be conceived by those skilled in the art, and forms configured by combining constituent elements in different embodiments without departing from the teachings of the present invention are included in the scope of the present invention.

### INDUSTRIAL APPLICABILITY

The present invention is applicable to control devices, and particularly a control device in a network including the control device and multiple terminal devices.

### REFERENCE SIGNS LIST

100, 2202, 2302, 2402, 2502, 2602, 2702 Relay device (Control device)
102 Receiving unit
103 Storing unit
104 Determining unit
106 Translating unit
108 Transmitting unit
109, 110, 112, 114, 124, 126, 128, 130, 138, 316, 318, 320, 322, 324, 326, 328, 330, 332, 428, 430, 432, 434, 436, 438, 440, 442, 444, 446, 448, 450, 452, 454, 516, 518, 520, 522, 524, 526, 528, 530, 532, 628, 630, 632, 634, 636, 638, 640, 642, 644, 646, 648, 650, 652, 654, 760, 762, 764, 766, 767, 768, 770, 772, 774, 776, 778, 780, 782, 784, 786, 788, 790, 792, 794, 795, 796, 797, 798 Connection
116, 118, 120, 122 Network
136 Wireless communication interface
140, 142, 144, 146, 148, 150, 152, 154, 156, 158, 160, 162, 2000, 2002, 2004, 2006, 2008, 2010, 2012, 2014, 2016 Wireless node (Terminal device)
200 Processing unit
202 Input and output unit
204 Memory
206 Storage
300, 400, 700 Interactive device evaluator
302, 402, 502, 602, 610, 702, 710, 718, 726, 734 Database retriever
304, 404, 504, 604, 704, 720, 738 Address tagger
306, 406, 706 Interactive threshold detector
308, 418, 742 Interactive device database
310, 422, 510, 622, 752 Message parser
312, 424, 512, 624, 754 Database updater
314, 426, 514, 626, 758 Message constructor
408, 708 User presence evaluator
410 Database retriever
412, 712 User presence threshold detector
414, 614, 714, 730 Address untagger
416, 616, 740 Frame storage
420, 744 User presence database
500, 600, 716 Application protocol evaluator
506, 606, 722 Application protocol threshold detector
508, 618, 746 Application protocol database
608, 724 Functionality presence evaluator
612, 728 Device/service functionality mapper
620, 748 Device functionality database
732 Communication standard evaluator
736 Communication standard threshold detector
750 Communication standard database
756 State switcher
1500, 1600, 1900 Unique_Device_ID
1502 Interactive_Status
1602 Last_User_Interacted_Date
1604 Last_User_Interacted_Time
1606 Device_Status
1902 Communication_Standard
1904 Battery_Powered
2018 Group X
2020 Group Y
2022 Network
2100 IN-TRANSFORMATION message
2102 MSG_PAYLOAD
2104 IN_TRANS_STATE
2106, 2108, 2110 DEST_ADDRESS 0 to N
2200, 2300, 2600, 2700 Source (Source node)
2204, 2304, 2412, 2510 Television
2206, 2312 User
2208, 2306 Laptop
2210, 2308, 2410, 2508 Video player
2212, 2310, 2400, 2500 Air conditioner
2316 Interactive devices
2404, 2504 Window blinds
2408, 2506 Washing machine
2604, 2704 Five 802.11-based terminal devices
2606, 2706 One ZigBee-based terminal device
2608, 2708 One 6LoWPAN-based terminal device
2610, 2710 One WM-Bus-based terminal device
2612, 2712 One Z-Wave-based terminal device
2614, 2714 One Bluetooth-based terminal device
2616, 2716 One Ethernet-based terminal device
2618, 2718 One M-Bus-based terminal device

1. A control device in a network including the control device and a plurality of terminal devices, the control device comprising:
a receiving unit configured to receive, in the network, a multi-address message transmitted from each of the terminal devices;
a determining unit configured to determine whether or not the received multi-address message is to be translated into a unicast message to be transmitted to a specified terminal device, based on information contained in the multi-address message, the specified terminal device being included in the terminal devices;
a translating unit configured to translate the multi-address message into the unicast message when the determining unit determines that the multi-address message is to be translated; and
a transmitting unit configured to transmit the unicast message to the specified terminal device.

2. The control device according to claim 1,
wherein the network has a plurality of different protocols in a data link layer.

3. The control device according to claim 2,
wherein, when the determining unit determines that the multi-address message is not to be translated into the unicast message, the transmitting unit is configured to translate the multi-address message into a multi-address message for each of the different protocols and transmit the translated multi-address message.

4. The control device according to claim 1,
wherein the determining unit is configured to identify, as the specified terminal device, from among the terminal devices, a terminal device including a display unit which presents information to a user.

5. The control device according to claim 1,
wherein the determining unit is configured to identify, as the specified terminal device, from among the terminal devices, a terminal device into which a user inputs information during a particular time period.

6. The control device according to claim 5,
wherein the terminal devices are consumer electronic appliances, and
the determining unit is configured to identify, as the specified terminal device into which the user inputs information, a consumer electronic appliance which is operated by the user during the particular time period.

7. The control device according to claim 1,
wherein the determining unit is configured to identify, as the specified terminal device, from among the terminal devices, a terminal device supporting a particular communication protocol.

8. The control device according to claim 7,
wherein the particular communication protocol uses Universal Plug and Play (UPnP).

9. The control device according to claim 1,
wherein the determining unit is configured to identify, as the specified terminal device, from among the terminal devices, a terminal device having a particular functionality.

10. The control device according to claim 1,
wherein the determining unit is further configured to determine, for each of communication protocols supported by the terminal devices, whether or not the multi-address message is to be translated into the unicast message to be transmitted.

11. The control device according to claim 10,
wherein the communication protocol is at least one of ZigBee, Institute of Electrical and Electronics Engineers (IEEE) 802.11, IEEE 802.15.4, Z-Wave, ECHONET, KNX, and Bluetooth®.

12. A relay method for relaying data in a network including a control device and a plurality of terminal devices, the relay method comprising:
receiving, in the network, a multi-address message transmitted from each of the terminal devices;
determining whether or not the received multi-address message is to be translated into a unicast message to be transmitted to a specified terminal device, based on information contained in the multi-address message, the specified terminal device being included in the terminal devices;
translating the multi-address message into the unicast message when, in the determining, it is determined that the multi-address message is to be translated; and
transmitting the unicast message to the specified terminal device.

13. (canceled)

14. A non-transitory computer-readable recording medium having recorded thereon a program causing a computer to execute the relay method according to claim 12.

15. An integrated circuit for implementing the relay method according to claim 12.
